(19) United States
(12) Patent Application Publication
(10) Pub. No.: US 2026/0323675 A1
(43) Pub. Date: Oct. 15, 2026

(54) RESOURCE ALLOCATION FOR NETWORK ACCESS

(71) Applicant: Samsung Electronics Co., Ltd., Suwon-si (KR)

(72) Inventors: Marian Rudolf, Longueuil (CA); Emad Nader Farag, Flanders, NJ (US); Aristides Papasakellariou, Houston, TX (US); Ebrahim MolavianJazi, San Jose, CA (US); Hongbo Si, Allen, TX (US)

(21) Appl. No.: 19/577,211

(22) Filed: Mar. 24, 2026

Related U.S. Application Data
(60) Provisional application No. 63/788,460, filed on Apr. 14, 2025.

(51) Int. Cl. H04W 72/51; H04L 5/00; H04W 72/0453

(52) U.S. Cl. CPC H04W 72/51; H04L 5/0094; H04W 72/0453

(57) ABSTRACT

Apparatuses and methods for resource allocation for network access including for sixth generation (6G) radio access. A method performed by a user equipment includes receiving first information for a first parameters for a first frequency-domain allocation associated with a downlink (DL) bandwidth for receptions on a cell, receiving second information for a second parameters for a second frequency-domain allocation associated with a DL bandwidth for receptions by a reduced bandwidth/complexity UE on the cell, and determining a third frequency-domain allocation associated with a DL bandwidth for receptions on a symbol by excluding a resource block (RB)/a resource block group (RBG) from a second set of RBs/RBGs of the second frequency-domain allocation from a first set of RBs or RBGs of the first frequency-domain allocation. The method further includes one of receiving an RB/RBG in of the first or third frequency-domain allocation on the symbol on the cell.

### CROSS-REFERENCE TO RELATED AND CLAIM OF PRIORITY

The present application claims priority under 35 U.S.C. § 119(e) to U.S. Provisional Patent Application No. 63/788,460 filed on Apr. 14, 2025, which is hereby incorporated by reference in its entirety.

### TECHNICAL FIELD

The present disclosure relates generally to wireless communication systems and, more specifically, the present disclosure is related to user equipment procedures with reduced capabilities, to resource allocation for network access including for sixth generation (6G) radio access in a wireless communication system.

### BACKGROUND

6G is recently gathering increased momentum with all the worldwide technical activities on the various candidate technologies from industry and academia. The candidate enablers for the 6G mobile communications include massive antenna technologies, from legacy cellular frequency bands up to high frequencies, to provide beamforming gain and support increased capacity, waveform design to flexibly accommodate various services/applications with different requirements, new multiple access schemes to support massive connections, artificial intelligence (AI)/machine learning (ML), and so on.

### SUMMARY

The present disclosure relates to resource allocation for network access including for 6G radio access.

In one embodiment, a method of operating a user equipment (UE) is provided. The method includes receiving first information for a first set of parameters for a first frequency-domain allocation associated with a downlink (DL) bandwidth for receptions on a cell, receiving second information for a second set of parameters for a second frequency-domain allocation associated with a DL bandwidth for receptions by a reduced bandwidth or a reduced complexity UE on the cell, and determining a third frequency-domain allocation associated with a DL bandwidth for receptions on a symbol by excluding a resource block (RB) or a resource block group (RBG) from a second set of RBs or RBGs of the second frequency-domain allocation from a first set of RBs or RBGs of the first frequency-domain allocation. The first set of RBs of RBGs of the first frequency-domain allocation corresponds to a set of RBs or RBGs based on one of a carrier bandwidth, a bandwidth part (BWP), or a frequency-domain allocation with upper and lower limits. The second set of RBs or RBGs of the second frequency-domain allocation corresponds to a subset of the first RBs or RBGs of the first frequency-domain allocation. The method further includes one of receiving an RB or RBG of the third frequency-domain allocation on the symbol on the cell when reception on the second frequency-domain allocation is not enabled for the UE or receiving an RB or RBG of the first frequency-domain allocation on the symbol on the cell when reception on the first or second frequency-domain allocation is enabled for the UE.

In another embodiment, a UE is provided. The UE includes a transceiver configured to receive first information for a first set of parameters for a first frequency-domain allocation associated with a DL bandwidth for receptions on a cell and receive second information for a second set of parameters for a second frequency-domain allocation associated with a DL bandwidth for receptions by a reduced bandwidth or a reduced complexity UE on the cell. The UE further includes a processor operably coupled to the transceiver. The processor is configured to determine a third frequency-domain allocation associated with a DL bandwidth for receptions on a symbol by excluding a RB or a RBG from a second set of RBs or RBGs of the second frequency-domain allocation from a first set of RBs or RBGs of the first frequency-domain allocation. The first set of RBs of RBGs of the first frequency-domain allocation corresponds to a set of RBs or RBGs based on one of a carrier bandwidth, a BWP, or a frequency-domain allocation with upper and lower limits. The second set of RBs or RBGs of the second frequency-domain allocation corresponds to a subset of the first RBs or RBGs of the first frequency-domain allocation. The transceiver is further configured to one of receive an RB or RBG of the third frequency-domain allocation on the symbol on the cell when reception on the second frequency-domain allocation is not enabled for the UE or receive an RB or RBG of the first frequency-domain allocation on the symbol on the cell when reception on the first or second frequency-domain allocation is enabled for the UE.

In yet another embodiment, a base station is provided. The base station includes a processor and a transceiver operably coupled to the processor. The transceiver is configured to transmit first information for a first set of parameters for a first frequency-domain allocation associated with a DL bandwidth for transmissions on a cell and transmit second information for a second set of parameters for a second frequency-domain allocation associated with a DL bandwidth for transmissions to a reduced bandwidth or a reduced complexity UE on the cell. A third frequency-domain allocation associated with a DL bandwidth for transmissions on a symbol is based on excluding a RB or a RBG from a second set of RBs or RBGs of the second frequency-domain allocation from a first set of RBs or RBGs of the first frequency-domain allocation. The first set of RBs of RBGs of the first frequency-domain allocation corresponds to a set of RBs or RBGs based on one of a carrier bandwidth, a BWP, or a frequency-domain allocation with upper and lower limits. The second set of RBs or RBGs of the second frequency-domain allocation corresponds to a subset of the first RBs or RBGs of the first frequency-domain allocation. The transceiver is further configured to one of transmit an RB or RBG of the third frequency-domain allocation on the symbol on the cell when transmission on the second frequency-domain allocation is not enabled for the UE or transmit an RB or RBG of the first frequency-domain allocation on the symbol on the cell when transmission on the first or second frequency-domain allocation is enabled for the UE.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example transmit receive point (TRP) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for physical downlink shared channel (PDSCH) in a subframe according to embodiments of the present disclosure;

FIG. 6 illustrates an example of a receiver structure for PDSCH in a subframe according to embodiments of the present disclosure;

FIG. 7 illustrates an example of a transmitter structure for physical uplink shared channel (PUSCH) in a subframe according to embodiments of the present disclosure;

FIG. 8 illustrates an example of a receiver structure for a PUSCH in a subframe according to embodiments of the present disclosure;

FIG. 9 illustrates an example of a transmitter structure for beamforming according to embodiments of the present disclosure;

FIG. 10 illustrates an example timeline of a reception or transmission sequence with frequency hopping across bandwidth parts (BWPs) or subbands by a reduced complexity UE according to embodiments of the present disclosure;

FIG. 11 illustrates an example method for determination of downlink (DL) usable resource blocks (RBs) in a DL carrier bandwidth (BW) according to embodiments of the present disclosure;

FIG. 12 illustrates an example method for determination of DL usable RBs based on an enhanced machine-type communication (eMTC) narrowband in a DL carrier BW according to embodiments of the present disclosure;

FIG. 13 illustrates an example timeline of a reception or transmission sequence with frequency hopping across BWPs or subbands by a reduced complexity UE using a reference BWP according to embodiments of the present disclosure;

FIG. 14 illustrates an example method for PDSCH reception using frequency hopping within a reference BWP according to embodiments of the present disclosure;

FIG. 15 illustrates an example method for determination of a virtual resource block to physical resource block (VRB-to-PRB) mapping based on DL usable RBs according to embodiments of the present disclosure;

FIG. 16 illustrates an example method for determination of a frequency hopping pattern based on a symbol or slot type according to embodiments of the present disclosure; and

FIG. 17 illustrates an example method performed by a UE according to embodiments of the present disclosure.

### DETAILED DESCRIPTION

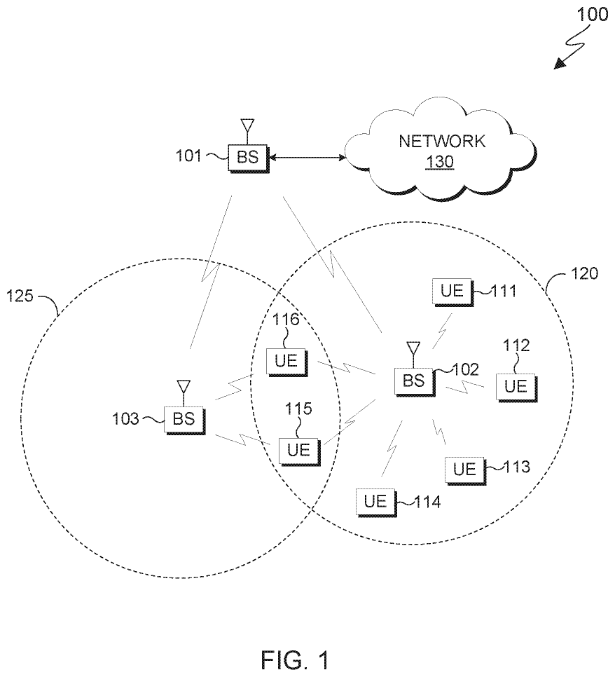

FIGS. 1-17 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 23-39 GHz or 60 GHz bands, so as to accomplish higher data rates or in lower frequency bands, such as 3.7/3.8 GHz, to enable robust coverage and mobility support.

The discussion of 6G systems and frequency bands associated therewith is for reference as certain embodiments of the present disclosure may be implemented in 6G systems. However, the present disclosure is not limited to 6G systems, or the frequency bands associated therewith, and embodiments of the present disclosure may be utilized in connection with any frequency band. For example, aspects of the present disclosure may be applied to deployment of 6G communication systems, to deployment of 5G/NR communication systems, to deployment of 4G/LTE communication systems, or even for deployment which may use terahertz (THz) bands in later releases.

The following documents and standards descriptions are hereby incorporated by reference into the present disclosure as if fully set forth herein: 3GPP TS 38.211 v18.4.0, “NR; Physical channels and modulation” (herein, “REF 1”); 3GPP TS 38.212 v18.4.0, “NR; Multiplexing and Channel coding” (herein, “REF 2”); 3GPP TS 38.213 v18.4.0, “NR; Physical Layer Procedures for Control” (herein, “REF 3”); 3GPP TS 38.214 v18.4.0, “NR; Physical Layer Procedures for Data” (herein, “REF 4”); 3GPP TS 38.321 v18.3.0, “NR; Medium Access Control (MAC) protocol specification” (herein, “REF 5”); 3GPP TS 38.331 v18.3.0, “NR; Radio Resource Control (RRC) Protocol Specification” (herein, “REF 6”); 3GPP TS 36.211 v18.0.0, “E-UTRA; Physical channels and modulation” (herein, “REF 7”); 3GPP TS 36.212 v18.1.0, “E-UTRA; Multiplexing and Channel coding” (herein, “REF 8”); 3GPP TS 36.213 v18.3.0, “E-UTRA; Physical Layer Procedures” (herein, “REF 9”); 3GPP TS 36.331 v18.4.0, “E-UTRA; Radio Resource Control (RRC) Protocol Specification” (herein, “REF 10”); and 3GPP TS 37.340 v18.3.0, “Evolved Universal Terrestrial Radio Access (E-UTRA) and NR; Multi-connectivity; Overall Description; Stage 2” (herein, “REF 11”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, eNB, gNB, aNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 6G, 5G/NR, 4G/long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station (aNB), a macrocell, a femtocell, a WiFi access point (AP), or other wirelessly enabled devices. Base stations may provide wireless access in accordance with one or more wireless communication protocols, e.g., 6G, or 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for operation in a wireless communication system, and more specifically for supporting resource allocation for network access including for 6G radio access. In certain embodiments, one or more of the BSs 101-103 include circuitry, programing, or a combination thereof to support operation in a wireless communication system, and more specifically to support resource allocation for network access including for 6G radio access.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

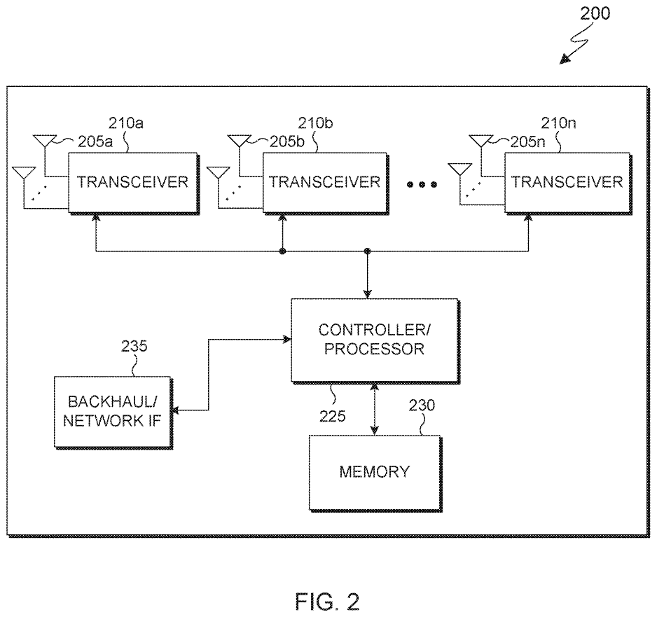

FIG. 2 illustrates an example TRP 200 according to embodiments of the present disclosure. For example, the TRP 200 may be a base station, such as BS 101-103, or may be an NCR or smart repeater (SR). The embodiment of the TRP 200 illustrated in FIG. 2 is for illustration only. However, TRPs come in a wide variety of configurations, and FIG. 2 does not limit the scope of this disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs or BSs in the network 100. In various embodiments, certain of the transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals. For example, in embodiments where the TRP is a repeater, one or more of the transceivers 210 may be used for an NCR-RU entity or NCR-Fwd entity as a DL connection for signaling over an access link with a UE and/or over a backhaul link with a BS. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or uplink (UL) connection for control signaling over a control link (C-link) with a BS.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for operation in a 6G or 5G/NR wireless communication system, including methods supporting resource allocation for network access including for 6G radio access. Any of a wide variety of other functions could be supported in the TRP 200 by the controller/processor 225.

The controller/processor 225 is also capable of executing programs and other processes resident in the memory 230, such as processes supporting resource allocation for network access including for 6G radio access. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 6G, 5G/NR, LTE, or LTE-A), the interface 235 could allow the TRP 200 to communicate with other BSs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a BS over a backhaul link for control signaling and/or data to be transmitted to and/or received from a UE. When the TRP 200 is implemented as an access point, the interface 235 could allow the TRP 200 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

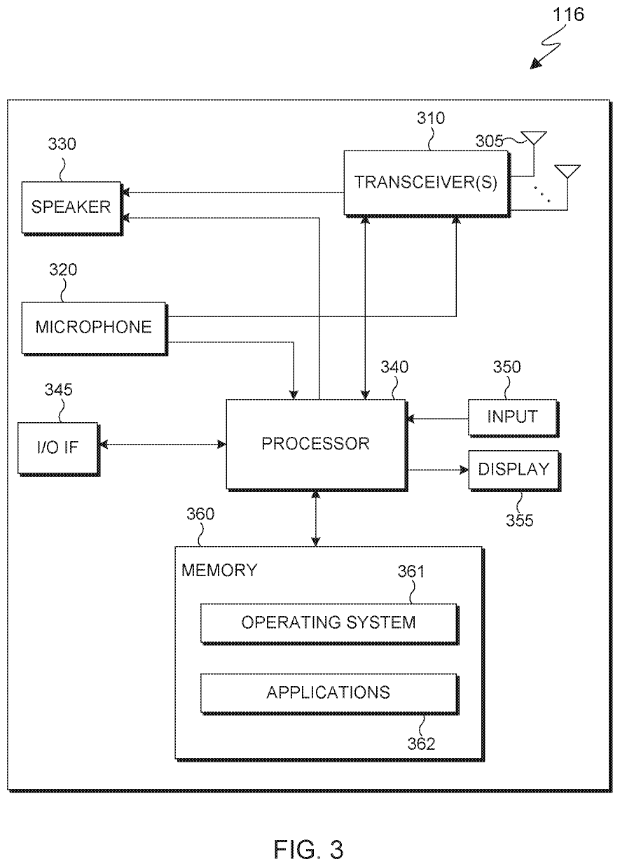

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for operation in a 6G or 5G/NR wireless communication system, including processes supporting resource allocation for network access including for 6G radio access as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

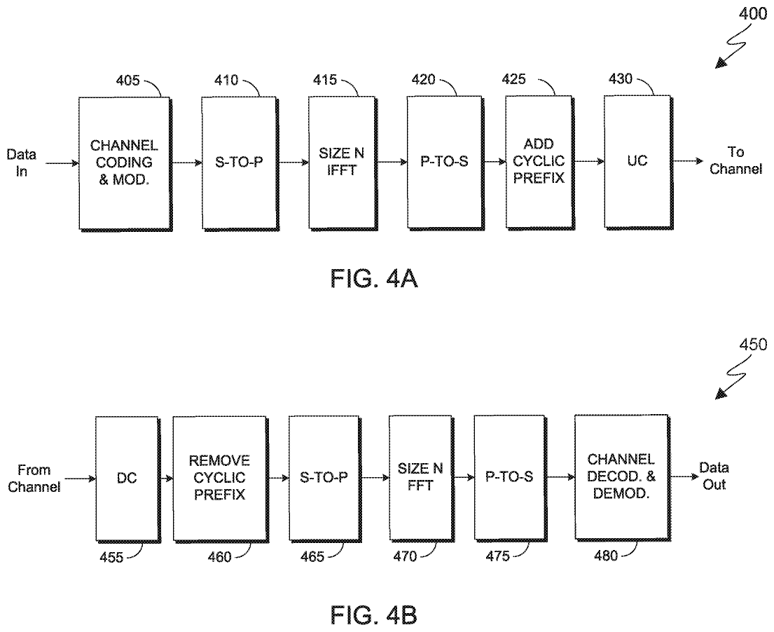

FIG. 4A and FIG. 4B illustrate an example of wireless transmit and receive paths 400 and 450, respectively, according to embodiments of the present disclosure. For example, a transmit path 400 may be described as being implemented in a BS or TRP (such as BS 102 or TRP 200), while a receive path 450 may be described as being implemented in a UE (such as UE 116). However, it will be understood that the receive path 450 can be implemented in a BS or TRP and that the transmit path 400 can be implemented in a UE. In some embodiments, the transmit path 400 and/or the receive path 450 is configured for operation in a 6G or 5G/NR or 4G/LTE wireless communication system, and more specifically for supporting resource allocation for network access including for 6G radio access as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 or the TRP 200 and may implement a receive path 450 for receiving in the downlink from the BSs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted, and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A subframe can include one or more slots and can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in REF 2, are referred for brevity as a unicast DCI format. A DCI format scheduling PDSCH reception for multicast communication, such as a DCI format with CRC scrambled by G-RNTI/G-CS-RNTI as described in REF 2, are referred to as multicast DCI format. DCI formats providing various control information to at least a subset of UEs in a serving cell, such as DCI format 2_0 in REF 2, are referred to as group-common (GC) DCI formats.

A BS (such as the BS 102) transmits one or more of multiple types of RS including channel state information RS (CSI-RS) and demodulation RS (DM-RS). A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a BS (such as the BS 102). Transmission instances of a CSI-RS can be indicated by DL control signaling or be configured by higher layer signaling. For example, using 6G, 5G/NR, or 4G/LTE, a DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a BS to perform UL channel measurement, and a RA preamble enabling a UE to perform random access. A UE transmits data information or UCI through a respective PUSCH or a physical UL control channel (PUCCH). A PUSCH or a PUCCH can be transmitted over a variable number of slot symbols including one slot symbol. The BS can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a BS to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a BS of a largest modulation and coding scheme (MCS) for the UE to detect a data TB with a predetermined block error rate (BLER), such as a 10% BLER (see NR specification), of a precoding matrix indicator (PMI) informing a BS how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A BS can use a DM-RS to demodulate information in a respective PUSCH or PUCCH. SRS is transmitted by a UE to provide a BS with an UL CSI and, for a TDD system, an SRS transmission can also provide a PMI for DL transmission. Additionally, in order to establish synchronization or an initial higher layer connection with a BS, a UE can transmit a physical random-access channel (PRACH) as shown in 5G/NR specifications.

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the BS, or a spatial Rx filter for reception of uplink channels or signals at the BS.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The BS can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{Dj}. UL TCI states are configured by higher layer parameter UL-TCIState, wherein the number of UL TCI states is N_{U}. N=N_{Dj}+N_{U}. The DLorJoint-TCIState can include DL or Joint TCI states for a serving cell. The source RS of the TCI state may be associated with the serving cell, e.g., the PCI of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_ 2 or DCI format 1_ 3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS, and the CSI-RS has the SSB as its source, e.g., for a QCL Type D relation or a spatial relation. The indirect QCL relation to an SSB can involve a QCL or spatial relation chain of more than one CSI-RS.

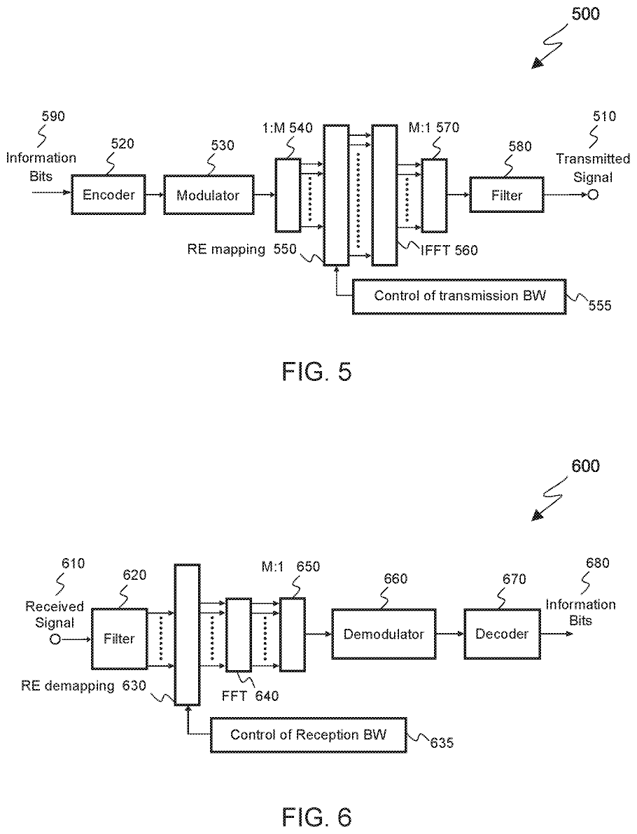

FIG. 5 illustrates an example of a transmitter structure 500 for PDSCH in a subframe according to embodiments of the present disclosure. For example, transmitter structure 500 can be implemented in BS 102 of FIG. 1. This example is for illustration only and other embodiments can be used without departing from the scope of the present disclosure.

As illustrated in FIG. 5, information bits 510 are encoded by encoder 520, such as a turbo encoder, and modulated by modulator 530, for example using Quadrature Phase Shift Keying (QPSK) modulation. A Serial to Parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse Fast Fourier Transform (IFFT), the output is then serialized by a Parallel to Serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates an example of a receiver structure 600 for PDSCH in a subframe according to embodiments of the present disclosure. For example, receiver structure 600 can be implemented by any of the UEs 111-116 of FIG. 1. This example is for illustration only and other embodiments can be used without departing from the scope of the present disclosure.

As illustrated in FIG. 6, a received signal 610 is filtered by filter 620, REs 630 for an assigned reception BW are selected by BW selector 635, unit 640 applies a Fast Fourier Transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

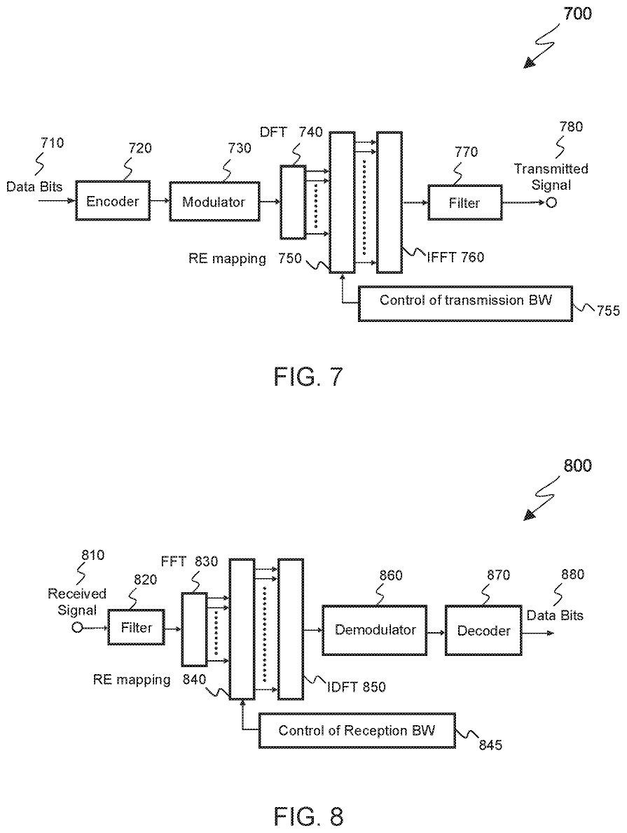

FIG. 7 illustrates an example of a transmitter structure 700 for PUSCH in a subframe according to embodiments of the present disclosure. For example, transmitter structure 700 can be implemented in BS 102 of FIG. 1. This example is for illustration only and other embodiments can be used without departing from the scope of the present disclosure.

As illustrated in FIG. 7, information data bits 710 are encoded by encoder 720, such as a turbo encoder, and modulated by modulator 730. A Discrete Fourier Transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates an example of a receiver structure 800 for a PUSCH in a subframe according to embodiments of the present disclosure. For example, receiver structure 800 can be implemented by any of the UEs 111-116 of FIG. 1. This example is for illustration only and other embodiments can be used without departing from the scope of the present disclosure.

As illustrated in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an Inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

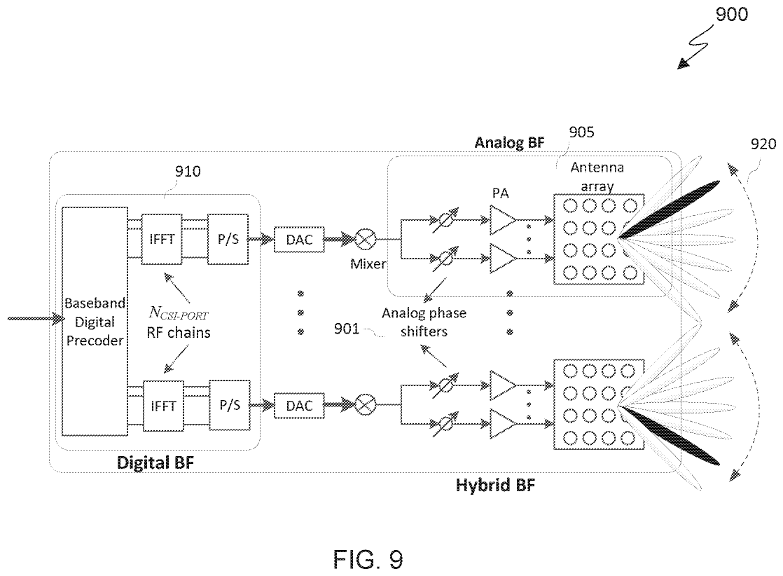

FIG. 9 illustrates an example of a transmitter structure 900 for beamforming according to embodiments of the present disclosure. In certain embodiments, one or more of BS 102, TRP 200, or UE 116 includes the transmitter structure 900. For example, one or more of antenna 205 and its associated systems or antenna 305 and its associated systems can be included in transmitter structure 900. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 9. Then, one CSI-RS port can be mapped onto a large number of antenna elements that can be controlled by a bank of analog phase shifters 901. One CSI-RS port can then correspond to one sub-array which produces a narrow analog beam through analog beamforming 905. This analog beam can be configured to sweep across a wider range of angles 920 by varying the phase shifter bank across symbols or slots/subframes. The number of sub-arrays (equal to the number of RF chains) is the same as the number of CSI-RS ports NCSI-PORT. A digital beamforming unit 910 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 900 of FIG. 9 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 9 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

In the present disclosure, the frequency resolution (reporting granularity) and span (reporting bandwidth) of CSI or calibration coefficient reporting can be defined in terms of frequency “subbands” and “CSI reporting band,” respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or indicated dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mn subbands within the CSI reporting band. A CSI parameter is configured with “subband” for the CSI reporting band with Mn subbands when one CSI parameter is reported for each of the Mn subbands within the CSI reporting band.

In the following and throughout the disclosure, various embodiments of the disclosure may be also implemented in any type of UE including, for example, 6G UEs, or UEs with the same, similar, fewer or more capabilities compared to a Rel-21 6G or a Rel-15 5G/NR UE. Although various embodiments of the disclosure discuss 3GPP 6G or 5G/NR wireless communication systems, the embodiments may apply in general to UEs operating with other RATs and/or standards, such as 4G/LTE or next releases/generations of 3GPP, IEEE Wi-Fi, and so on.

For example, RRC signaling such as configuration by RRC signaling may include (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

For example, MAC CE signaling can be UE-specific e.g., to one UE and can be UE common (e.g., to a group of UEs or to UEs in a cell). MAC CE signaling can be DL MAC CE signaling or UL MAC CE signaling.

For example, L1 control signaling may include: (1) DL control information (e.g., DCI on PDCCH or DL control information on PDSCH) and/or (2) UL control information (e.g., UCI on PUCCH or PUSCH). L1 control signaling can be UE-specific e.g., to one UE and can be UE common (e.g., to a group of UEs or to all UEs in a cell).

For example, the term ‘configuration’ can refer to configuration by semi-static signaling such as RRC. In one example, a configuration can be applicable to multiple reception instances or multiple transmission instances, until a configuration is received and applied.

For example, the term ‘activation’ can describe an operation wherein a UE receives and decodes a signal from the network (or BS) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” can describe an operation wherein a UE receives and decodes a signal from the network (or BS) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

For example, the term ‘indication’ can refer to indication by dynamic signaling (e.g., L1 control such as DCI or MAC CE signaling). In one example, an indication can be for an associated occasion(s) (e.g., an occasion or multiple occasions associated with the indication).

For example, the term ‘semi-static signaling’ can be used for configuration of channels or signals with periodic resources, for configuration of periodic reports. For example, configuration of Type-1 configured grant (CG) PUSCH or periodic CSI-RS or periodic CSI reports on PUCCH. The resources can become active after configuration.

For example, the term ‘dynamic signaling’ can be used for activation of semi-persistent channels or signal or the activation of semi-persistent reports. For example, configuration of Type-2 configured grant (CG) PUSCH or semi-persistent CSI-RS or semi-persistent CSI reports on PUCCH or PUSCH. The resources become active and are transmitted periodically after activation and until they are deactivated.

For example, dynamic signaling can be used for indication or triggering of aperiodic channels or signals or indication or triggering of aperiodic reports. The channel, signal or report can be transmitted/received once (e.g. one-shot) or N times (e.g., N-shots). For example, PUSCH scheduled by an UL grant in a DCI or aperiodic CSI-RS or aperiodic CSI reports on PUSCH.

For example, a list with N elements or entries can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the following, monitoring of a channel or signal corresponds to the operations of receiving the channel or signal and decoding to obtain information provided by the channel or signal. For example, a PDCCH monitoring occasion is a time period where the UE receives candidate PDCCHs and decodes for DCI that would be provided by the candidate PDCCHs.

In the following, unless otherwise explicitly noted, providing a parameter value by higher layers includes providing the parameter value by a system information block (SIB), such as a SIB1, or by a common RRC signaling, or by UE-specific RRC signaling, or by core network signaling between a UE and a network node.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=21 for Rel-21, or xx=22 for Rel-22, etc.

For example, a time unit, for example, can be a symbol or a slot or a sub-frame or a frame. In one example, a time-unit can be multiple symbols, or multiple slots or multiple subframes or multiple frames. In one example, a time-unit can be a sub-slot (e.g., part of a slot). For example, a time-unit can be specified in units of time, e.g., microseconds, or milliseconds or seconds, etc.

For example, a frequency-unit can be a sub-carrier (SC) or a resource block (RB) or a sub-channel, wherein a sub-channel is a group of SCs or RBs, or a bandwidth part (BWP). In one example, a frequency-unit can be multiple sub-carriers, or multiple RBs or multiple sub-channels. For example, a frequency-unit can be a sub-RB (e.g., part of an RB). A frequency-unit can be specified in units of frequency, e.g., Hz, or kHz or MHz, etc.

For example, a measurement signal or a measurement resource may correspond to one or more of the following:
Aperiodic or semi-persistent or periodic CSI-RS for channel measurements.
Aperiodic or semi-persistent or periodic CSI-IM (channel state information-interference measurement) (or zero power (ZP) CSI-RS) for interference measurements.
Aperiodic or semi-persistent or periodic non-zero power (NZP) CSI-RS for interference measurements
On-demand (OD) signal for synchronization, e.g., OD-SS/PBCH Block (OD-SSB), or OD-SS, wherein OD-SS includes PSS and/or SSS or OD-low-power (LP)-SS. The OD signal for synchronization can be transmitted one or more times, or activated by a first signal/channel and transmitted periodically until it is deactivated by a second signal/channel, subject to processing latency.
Always-on (AO) signal for synchronization, e.g., AO-SS/PBCH Block (AO-SSB), or AO-SS, wherein AO-SS includes PSS and/or SSS or AO-LP-SS. The AO signal for synchronization can be configured by higher layer to be a periodic signal or a periodic burst of signals.

For example, uplink control information (UCI) may correspond to one or more of the following such as defined in REF3 with other or additional types of UCI not precluded:
Hybrid automatic repeat request acknowledgment (HARQ-ACK) for DL transport blocks or PDCCH transmissions without PDSCH.
Scheduling request (SR).
Channel state information (CSI) reports. For example, a CSI report can be a single part CSI report. In another example, a CSI report can be a two-part CSI report, e.g., a first part CSI report and a second part CSI report.
Link recovery request (LRR), this can be similar to SR.
UE initiated report indicator (UEIRI).

In the following, for brevity of description, the higher layer provided TDD UL-DL frame configuration can refer to tdd-UL-DL-ConfigurationCommon as example for RRC common configuration and/or tdd-UL-DL-ConfigurationDedicated as example for UE-specific configuration. For example, when using 5G/NR, the UE may determine a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. For example, the UE may determine a dedicated TDD UL-DL frame configuration using the IE ServingCellConfig when the UE is configured with a serving cell, e.g., add or modify, where the serving cell may be the SpCell or an SCell of an MCG or SCG. For example, a TDD UL-DL frame configuration may designate a slot or symbol as one of types ‘D’, ‘U’ or ‘F’ using a time-domain pattern with configurable periodicity.

Throughout the disclosure, an SSB is used as a short form for a SS/PBCH block. The terms SSB and SS/PBCH block are interchangeably used in this disclosure.

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

In certain embodiments, a TCI state may be used for beam indication. A TCI state may refer to a DL TCI state for DL channels, e.g. PDCCH or PDSCH, an UL TCI state for UL channels, e.g. PUSCH or PUCCH, a joint TCI state for DL and UL channels, or separate TCI states for UL and DL channels or signals. A TCI state may be common across multiple component carriers or may be a separate TCI state for a component carrier of a set of component carriers. A TCI state may be BS or UE panel specific or common across panels. In some examples, an UL TCI state may be replaced by an SRS resource indicator (SRI).

In certain embodiments, a cell may include or consist of more than one transmission/reception point (TRP). For example, mTRP operation may be referred to as intra-cell mTRP operation. In one example, a TRP may be identified by a CORESETPoolIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on.

In certain embodiments, the term “FR1” or a frequency range designation “FR1” may refer to a corresponding frequency range 410-7125 MHz; the term “FR2-1” or a frequency range designation “FR2-1” may refer to a corresponding frequency range 24250-52600 MHz; the term “FR2-2” or a frequency range designation “FR2-2” may refer to a corresponding frequency range 52600-71000 MHz; the term “FR2” or a frequency-range designation “FR2” may refer to FR2-1 or FR2-2.

In certain embodiments, the term “FR3” or a frequency range designation “FR3” may refer to a corresponding frequency range 7125-24250 MHz, or parts thereof. For example, an FR3 band may correspond to 7125-8400 MHz, or parts thereof, in ITU Region 2 or ITU Region 3. For example, an FR3 band may correspond to 7125-7250 MHz or 7750-8400 MHz, or parts thereof, in ITU Region 1. For example, an FR3 band may correspond to 14800-15350 MHz, or parts thereof, in an ITU Region. For example, for simplicity and illustration purposes, the term “FR3 7-8 GHz” may be used to refer to 6G radio access on a carrier or in a band of a frequency range such as 7125-8400 MHz, or the term “FR3 14-15 GHz” may be used to refer to 6G radio access on a carrier or in a band of a frequency range such as 14800-15350 MHz. The term “FR3 7-8 GHz” may be used interchangeably with a term such as “FR3 band 7-8 GHZ” or “6G band 7-8 GHZ”.

In certain embodiments, 6G radio access may be supported on a carrier or in a band of a frequency range such as FR1 corresponding to 4400-4800 MHz, or in a carrier or in a band corresponding to an FR1 or an FR2 operating band as defined in REF 7. For example, the term “FR1 4 GHz” may be used interchangeably with a term such as “FR1 band 4 GHz” or “6G band 4 GHz”.

In certain embodiments, 5G/NR radio access (or 4G/LTE) may be supported on a carrier or in a band of a frequency range corresponding to an FR1 or an FR2 operating band as defined in REF 7 for the case of 5G/NR.

In certain embodiments, a UE supporting 6G radio access may operate in single RAT mode or may operate in dual RAT mode.

For example, when operating in single RAT mode, the UE may select one RAT, e.g., one of 4G/LTE or 5G/NR or 6G radio access to (re-)select and camp on a serving cell in a band when in RRC_IDLE or RRC_INACTIVE state. For example, when operating in single RAT mode, the UE may be indicted one or more serving cells corresponding to one RAT in one or more bands by the network using mobility or handover procedures when in RRC_CONNECTED state. For example, a UE supporting 6G radio access and operating in single RAT mode may also support 4G/LTE or 5G/NR radio access, or may also support other wireless radio access such as Wi-Fi or Bluetooth or UWB.

For example, a dual RAT mode may be based on carrier aggregation operation, or dual connectivity operation or dual active protocol stack operation. For example, when operating in dual RAT mode, a multiple Rx and/or multiple Tx capable UE may be concurrently or simultaneously active on two serving cells using a separate RAT for each serving cell, respectively, wherein a first RAT may correspond to 6G radio access, and a second RAT may correspond to 5G/NR radio access or to 4G/LTE radio access. For example, when operating in dual RAT mode, the UE may be indicated with a first cell group comprising one or more serving cells corresponding to the first RAT, and a second cell group comprising one or more serving cells corresponding to the second RAT. For example, the first cell group may correspond to an MCG, and the second cell group may correspond to an SCG with reference to carrier aggregation or dual connectivity. Serving cells or cell groups may be located in a same or in different bands. For example, a UE supporting 6G radio access and operating in dual RAT mode may also support 4G/LTE or 5G/NR radio access, or may also support other wireless radio access.

For example, when operating in dual RAT mode based on principles such as described in REF 11 for multi-RAT dual-connectivity operation for scenarios such as LTE-NR or NR-LTE or NR-NR, a UE supporting 6G radio access may be configured to utilize radio resources provided by two different nodes connected via non-ideal or ideal backhaul, one node providing 6G radio access and the other node providing either 4G/LTE or 5G/NR radio access. One node may act as a master node (MN) and the other as secondary node (SN), where the MN and SN are connected via a network interface and at least the MN is connected to the core network. Transmissions to the UE or receptions from the UE using 4G/LTE or 5G/NR radio access may then occur on a primary cell group (PCG), and transmissions to the UE or receptions from the UE using 6G radio access may then occur on a secondary cell group (SCG). In another example, 6G radio access may occur on the PCG and 4G/LTE or 5G/NR radio access may occur on the SCG. For example, when operating in dual RAT mode based on carrier aggregation, if supported by 6G radio access, the UE supporting 6G radio access may be scheduled per cell group and network-side scheduling between the first and the second cell group, respectively, may or may not be coordinated between the cell groups.

For example, when operating in dual RAT mode based on dual active protocol stack operation, the UE supporting 6G radio access may be connected to a 6G serving cell in a first band while being connected to a 4G/LTE or 5G/NR cell in a second band. In one example, a dual-active protocol stack UE maintains separate RRC states with respect to the radio access network, i.e., a first RRC state corresponding to the 6G radio access and a second RRC state corresponding to the 5G/NR or the 4G/LTE radio access. In one example, a dual-active protocol stack UE may maintain a same or separate mobility or connection states with respect to the core network, i.e., a first mobility or connection management state corresponding to the 6G radio access and a second mobility or connection state corresponding to the 5G/NR or the 4G/LTE radio access.

In certain embodiments, a UE supporting 6G radio access may transmit or receive on a carrier or in a band of a band combination according to carrier aggregation operation, or according to dual connectivity operation, or according to dual active protocol stack operation. Without loss of generality and for conciseness of description, the term “band combination” may refer to a band combination such as defined with respect to a carrier-aggregation band combination, or such as a dual connectivity band combination, or such as a dual active protocol stack band combination. For example, a UE supporting 6G radio access may operate in FDD mode or in TDD mode on a carrier or in a band. For example, the UE supporting 6G radio access may operate in a combination of FDD and/or TDD modes in a band or in a band combination.

In certain embodiments, the UE supporting 6G radio access may transmit or receive on a carrier or in a band of a band combination according to carrier aggregation operation, or according to dual connectivity operation, or according to dual active protocol stack operation using a single UL carrier, or using two or more UL contiguous or non-contiguous carriers. For example, based on single UL carrier operation, the UE supporting 6G radio access may transmit an UL signal or channel in a first UL carrier corresponding to 6G radio access or may transmit an UL signal or channel in a second UL carrier corresponding to 5G/NR radio access but the UL transmissions on the first and the second UL carrier then may occur separately in time-domain, e.g., in different slots or symbols, respectively, and the UE may switch between UL transmissions in the first and the second UL carrier, respectively. For example, the UE supporting 6G radio access may be capable of simultaneous UL transmission in two or more UL carriers in a same band or in different bands of a band combination. For example, a UE supporting 6G radio access using a single carrier or using two or more UL carriers may support a switching or a simultaneous UL transmission capability with respect to some or all UL signals or channel types. For example, the UE may support switching with respect to an UL signal of type SRS. For example, the UE may support simultaneous UL transmission capability with respect to an UL channel of type PUSCH on two or more UL carriers.

In certain embodiments, a UE supporting 6G radio access may operate according to a 6G reduced complexity (or reduced capability) (RC) feature. For example, the RC UE may support an internet of things (IoT) use case or may support an implementation according to a reduced complexity type of UE features or a minimum mandatory set of UE capability features; for example in order to lower the device cost, or to increase the achievable battery life or standby time, or to support a small form factor, or for deployment in certain deployment conditions when compared to a normal or a high-end device type such as using a smartphone form factor.

For example, the UE supporting 6G radio access according to the 6G RC feature (or 6G RC UE) may target DL data rates from several kbps to around several Mbps for use cases such as IoT or from around several Mbps to around 100 Mbps for reduced complexity UE implementation. For example, the 6G RC UE may support an UL or DL minimum coupling loss (MCL) of up to around 155 dB through a moderate number of repetitions, i.e., up to 32. For example, the 6G RC UE may support a standby time of up to several weeks or months for use cases such as IoT or a RC UE implementation.

For example, the 6G RC UE may operate in FR1 bands such as below 3 GHz for use cases such as IoT, or in FR1 or FR3 bands for reduced complexity UE implementations. For example, the 6G RC UE may operate based on 15 or 30 kHz SCS in FR1 or FR3. For example, the 6G RC UE may operate based on 120 or 240 kHz SCS in FR2.

For example, the UE supporting 6G radio access according to a 6G RC feature (or 6G RC UE) may implement one or more of a cost reduction technique when compared to other device types. For example, the 6G RC UE may operate according to a limited or restricted maximum RF bandwidth such as 3 or 5 MHz for a use case such as IoT or such as 20 MHz for a reduced complexity UE implementation. For example, the limited or restricted RF bandwidth may correspond to a maximum UE channel bandwidth BW_{UE,channel,max}. For example, the 6G RC UE may operate according to a limited or restricted maximum BB processing capability such as a maximum of 25 PRBs within a limited or restricted maximum RF bandwidth for reduced complexity UE implementation. For example, the 6G RC UE may operate according to a limited or restricted maximum RF bandwidth such as 20 MHz in the DL, or a limited or restricted BB processing capability such as 5 MHz or 25 PRBs within the restricted maximum RF bandwidth in the DL, or may operate according to a limited or restricted maximum RF bandwidth such as 5 MHz in the UL. For example, the 6G RC UE may operate according to FDD full-duplex mode, FDD half-duplex Type A or B modes, or according to TDD mode. For example, the 6G RC UE may perform DL receptions in a carrier or in a band based on 1 Rx antenna (or panel), or 2 Rx antennas (or panels), or more than 2 Rx antennas (or panels), or may implement limited or restricted support (including none) for a CSI-RS resource configuration, CSI reporting or MIMO operational capabilities. For example, the 6G RC UE may operate UL transmissions based on 1 Tx antenna (or panel). For example, the 6G RC UE may operate according to a PSM or a Cellular Internet of things (CIoT) feature. For example, the 6G RC UE may not support CA, or DC, or dual-protocol stack operation, i.e., and operate in single RAT mode. For example, the 6G RC UE may support to a limited or restricted maximum TB size, or support a limited or restricted set of modulation orders, or support a limited or restricted set of modulation-and-coding schemes when compared to other devices.

In certain embodiments, a UE may support a limited or restricted maximum UE channel bandwidth BW_{UE,channel,max} within a same spectrum for transmitting to or receiving from the BS. A UE channel bandwidth may be associated with a maximum transmission bandwidth configuration N_{RB} for a subcarrier spacing. For example, the UE channel bandwidth may support a single RF carrier in the UL or the DL at the UE. From a BS perspective, different UE channel bandwidths may be supported within the same spectrum for transmitting to and receiving from UEs connected to the BS. From a UE perspective, the UE may be configured with one or more BWPs in a carrier. The UE may not be aware of the BS channel bandwidth BW_{BS,channel} or how the BS allocates bandwidth to different UEs.

For example, when operating in an FDD band such as n66 (UL: 1710-1780 MHz, DL: 2110-2200 MHz), a set of UE channel bandwidth may correspond to BW_{UE,channel,n66}={5, 10, 15, 20, 25, 30, 35, 40} MHz for SCS=15 kHz. A normal or high-end UE may implement or be required to support some or all of UE channel bandwidths in the set BW_{UE,channel,n66} and support the maximum UE channel bandwidth 40 MHz for this band. A reduced complexity UE supporting up to a maximum UE channel bandwidth BW_{UE,channel,max}=20 MHz may implement and operate to a limited or a restricted channelization from the set {5, 10, 15, 20} MHz in this band.

For example, when operating in a TDD band such as n41 (UL/UL: 2496-2690 MHz), a set of UE channel bandwidth may correspond to BW_{UE,channel,n41}={10, 15, 20, 25, 30, 35, 40, 45, 50, 60, 70, 80, 90, 100} MHz for SCS=30 kHz. A normal or high-end UE may implement or be required to support some or all of UE channel bandwidths in the set BW_{UE,channel,n41} and support the maximum UE channel bandwidth 100 MHz for this band. A reduced complexity UE supporting up to a maximum UE channel bandwidth BW_{UE,channel,max}=20 MHz may implement and operate to a limited or a restricted channelization from the set {10, 15, 20} MHz in this band.

For example, when operating in an FDD band such as n5 (UL: 824-849 MHz, DL: 869-894 MHz), a set of UE channel bandwidth may correspond to BW_{UE,channel,n5}={5, 10, 15, 20} MHz for SCS=15 kHz. A normal or high-end UE may implement or be required to support some or all of UE channel bandwidths in the set BW_{UE,channel,n5} and support the maximum UE channel bandwidth 20 MHz in this band. A reduced complexity UE supporting up to a maximum UE channel bandwidth BW_{UE,channel,max}=5 MHz may implement and operate to a limited or a restricted channelization from the set {5} MHz in this band.

For example, a maximum transmission bandwidth configuration N_{RB} for a subcarrier spacing 15 kHz may correspond to 15 or 12 RBs for a UE channel bandwidth of 3 MHz, or to 25 or 20 RBs for a UE channel bandwidth of 5 MHz, or to 106 RBs for a UE channel bandwidth of 20 MHz using 15 kHz SCS, or to 51 RBs for a UE channel bandwidth of 20 MHz using 30 kHz SCS when operating in FR1.

In certain embodiments, a UE supporting a reduced complexity or reduced capability feature is provided with information associated with operation in bandwidth parts (BWPs).

For example, the UE is provided with a set of BWPs for receptions by the UE in a DL carrier bandwidth, i.e., a DL BWP set, or a set of BWPs for transmissions by the UE in an UL carrier bandwidth, i.e., an UL BWP set. For example, a frequency-domain occupancy of a BWP may be defined by a common RB N_{BWP}^{start}=O_{carrier}+RBₛₜₐᵣₜ and a number of contiguous RBs N_{BWP}^{size}=L_{RB} provided by parameter locationAndBandwidth that indicates an offset RBₛₜₐᵣₜ and a length L_{RB} as RIV according to [REF 4], by setting N_{BWP}^{size}=275, and a value O_{carrier} provided by parameter offsetToCarrier for the subcarrier Spacing.

For example, the UE receives or transmits in an active BWP from a set of configured BWPs N_{BWP}. For example, a size of N_{BWP}=2 or 4. For example, DL receptions or UL transmissions by the UE are limited or restricted to within the active BWP. For example, the UE does not receive a DL signal/channel or does not transmit an UL signal/channel outside its active BWP, except possibly for specific purposes such as an SRS transmission or a CSI-RS reception for positioning or a CSI estimation. The UE may determine an initial or default BWP under certain system operating conditions. For example, a set of DL and of UL BWPs, may be separately provided for DL receptions and UL transmissions, respectively. For unpaired spectrum operation, a DL BWP may be associated or linked with an UL BWP, and the UE does not expect to receive a configuration wherein the center frequency for the DL BWP is different than the center frequency for the UL BWP. For example, the BS may configure a same set of BWPs for different UEs or may configure different sets for different UEs. For example, the UE may support fast BWP switching, e.g., <140 μs, under certain system operation conditions. For example, to support fast BWP switching, the UE may apply a same SCS or apply a same BWP size or apply a same set of higher layer protocol parameters when switching the active BWP to another BWP in the set of configured BWPs. For example, the UE may be provided with a first set of BWPs having same aforementioned parameters, and may be provided with a second set of BWPs having same aforementioned parameters that are different from the ones of BWPs in the first set of BWPs, thereby enabling fast switching among BWPs within the first set of BWPs or within the second set of BWPs, and slower switching among BWPs in different sets of BWPs while also allowing flexibility in changing the values of the aforementioned and of other parameters. In this manner, both fast BWP switching with restrictions in the BWP parameters and slow BWP switching without restrictions in the BWP parameters can be simultaneously supported.

For example, when the UE operates according to inter-slot frequency-hopping based on BWP operation, the UE switches the active BWP to one of the configured BWPs provided in the set N_{BWP}. For example, the UE may switch a BWP in a last or a first number of symbols of a slot. For example, the BWP switching or hopping pattern with respect to frequency domain or time-domains may be defined by rules such as provided in system specifications, or may be provided to the UE by higher layer parameters. For example, BWP switching or hopping across more than one BWP by the UE may occur according to information provided by higher layers or may be associated with the reception of a DCI, e.g., such as when receiving a bandwidth part indicator field in a DCI or upon reception of a frequency-domain resource allocation field in a DL assignment or in an UL grant.

In certain embodiments, a UE supporting a reduced complexity or reduced capability feature is provided with information associated with a subband configuration in a carrier bandwidth.

For example, the UE is configured by higher layers or indicated by the BS one or more subbands for receptions by the UE in a DL carrier bandwidth, i.e., a set of DL subbands, or a set of one or more subbands for transmissions by the UE in an UL carrier bandwidth, i.e., a set of UL subbands. For example, a frequency-domain occupancy of one or more subbands may be provided to the UE with respect to a carrier bandwidth or a maximum transmission bandwidth configuration N_{RB}, e.g., by associating a sequence of RBs with a first, or a second, or a third subband, etc., or in a well-defined order for the RBs in a carrier bandwidth according to system operating specifications. For example, a number of subbands in a carrier bandwidth may correspond to

$${N}_{SB} = ⌊ \frac{{N}_{RB}}{15} ⌋$$

for a limited bandwidth UE with BW_{UE,channel}=3 MHz and the subbands may be numbered n_{SB}=0, . . . , N_{NB}−1 in order of increasing PRB numbers. For example, a frequency-domain occupancy of a subband may be defined by a common RB N_{SB}^{start}=O_{carrier}+RBₛₜₐᵣₜ and a number of contiguous RBs N_{SB}^{size}=L_{RB} provided by parameter locationAndBandwidth that indicates an offset RBₛₜₐᵣₜ and a length L_{RB} as RIV according to [REF 6], by setting N_{SB}^{size}=275, and a value O_{carrier} provided by parameter offsetToCarrier for the subcarrierSpacing.

The UE may receive a DL signal or channel in a DL subband from a set of provided subbands N_{SB,DL}. The UE may transmit an UL signal or channel in an UL subband from a set of provided subbands N_{SB,UL}. For example, the size of N_{SB,DL}=2 or 4, or N_{SB,UL}=2 or 4. For example, a set of DL and of UL subbands, may be separately provided for DL receptions and UL transmissions, respectively. The UE may determine an initial or default subband under certain system operating conditions. For example, the BS may configure a same set of subbands for different UEs or may configure different sets of subbands for different UEs. For example, the UE may support fast subband switching, e.g., <140 μs, under certain system operation conditions. For example, to support fast subband switching, the UE may apply a same SCS or apply a same subband size or apply a same set of higher layer protocol parameters when switching from a subband to another subband in the set of subbands.

For example, when the UE operates according to inter-slot frequency-hopping based on a subband in a carrier bandwidth, the UE may switch DL receptions from a first DL subband to a second DL subband in the set N_{SB,DL} according to system operation, or the UE may switch UL transmissions in a first UL subband to a second UL subband in the set N_{SB,UL} according to system operation conditions. For example, the subband switching or hopping pattern with respect to frequency domain or time-domain resources may be defined by rules such as provided in system specifications, or may be provided to the UE by higher layer parameters. For example, subband switching or hopping by the UE may occur according to information provided by higher layers or may be associated with the reception of a DCI, e.g., such as when receiving an indicator field in a DCI or upon reception of a frequency-domain resource allocation field in a DL assignment or in an UL grant.

In certain embodiments, a UE supporting a reduced complexity or reduced capability feature may operate based on a frequency hopping protocol in a set of BWPs or subbands in a carrier bandwidth.

For example, a first DL reception or UL transmission bandwidth of the UE in a symbol or slot may be limited or restricted. For example, the first DL reception or UL transmission bandwidth may be limited or restricted with respect to a size of a BWP, or a size of a subband, or a number of subcarriers, or a number or locations of RBs or of RBGs, or with respect to a maximum UE DL or UL channel bandwidth BW_{UE,channel,max}, or a maximum supported or indicated RF or BB bandwidth reception or transmission bandwidth of the UE. For example, the limited or restricted DL reception or UL transmission bandwidth of the UE may correspond to 3 MHz, or to 5 MHz, e.g., for a use case such as IoT, or may correspond to 20 MHz, e.g., for a UE supporting a reduced complexity implementation or reduced capability. A later second DL reception or UL transmission with the limited or restricted DL reception or UL transmission bandwidth may occur in another BWP or in another subband of a DL or UL carrier bandwidth or of a larger BS DL or UL channel bandwidth BW_{BS,channel}. For example, in cases such as a PDCCH, or a PDSCH, or a CSI-RS reception, or in cases such as a PUSCH, or a PUCCH, or a PRACH, or an SRS transmission, or in cases such as a PDCCH, or a PDSCH, or a PUSCH, or a PRACH, or an SRS repetition, or in cases such as a PDSCH or a PUSCH multi-slot scheduling, or in cases such as a reception or transmission of a PDSCH or a PUSCH according to TBoMS operation, frequency hopping in blocks of Nₕₒₚ symbols or slots may be applied for DL receptions or UL transmissions by the UE. For example, the frequency hopping may occur across different BWPs or across different subbands within the carrier bandwidth or the BS channel bandwidth. For example, the frequency hopping may occur across different symbols or slots.

For example, the UE may not expect to be provided with a BWP or subband configuration wherein one or more RBs can overlap between a first and second BWP or subband. For example, the UE may not expect to be provided with a set of BWPs or a set of subbands wherein a BWP or subband i is separated by fewer than a threshold X of RBs or RBGs from a BWP or subband j in the set to provide a minimum frequency separation for hopping across BWPs or subbands. For example, the UE may not expect to be provided with a set of BWPs or a set of subbands wherein a BWP or subband i is separated by more than a threshold Y of RBs or RBGs from a BWP or subband j in the set to provide a maximum frequency separation or maximum hopping width across the set BWPs or subbands or the carrier bandwidth.

A set of BWPs N_{BWP} or of subbands N_{SB} may be provided to the UE. For example, N_{BWP} may be provided as N_{BWP}=4. A parameter Fₕₒₚ associated with a subset or a number of BWPs or of subbands which are available for hopping in frequency-domain may be provided to the UE. For example, a size of Fₕₒₚ≤N_{BWP} or Fₕₒₚ≤N_{SB}. The UE may hop across BWPs or subbands based on a subset from the set of the provided BWPs or subbands including all of the BWPs or subbands. For example, a parameter Nₕₒₚ corresponding to a number of slots with a transmission or reception in a same BWP or subband may be provided to the UE. For example, Nₕₒₚ=1, and frequency hopping occurs in every slot, or Nₕₒₚ=4, and frequency hopping occurs every four slots. Other suitably selected time units such as a number of symbols or of subframes may be applied when describing a frequency hopping behavior. For example, the BWPs or the subbands in the carrier BW across which a hopping pattern is defined may be equally or unequally spaced in frequency-domain, or hopping in frequency-domain may use only some or all of the configured BWPs or subbands. For example, separate values corresponding to a frequency hopping parameter may be provided to the UE for the DL receptions and UL transmissions, respectively.

For example, in order to align the frequency hopping behavior between different transmissions from UEs and ensure that the UEs “hop” at the same time instant, the hopping instants may not be UE specific, and may be defined cell-common for the frequency-hopping UEs within a cell. For example, the hopping instants may be defined or selected with respect to the SFN and/or may be counted from the first slot in a frame with SFN=0 such that the hopping takes place between slot k*Nₕₒₚ−1 and slot k*Nₕₒₚ for the frequency-hopping transmissions regardless of the start of the transmission from the UE perspective. For example, a frequency-hopping block length Nₕₒₚ, or a hopping distance or hopping offset in frequency domain, or a set Fₕₒₚ associated with a set of BWPs or of subbands available for hopping may be provided to the UE using higher layer signaling such as cell-specific or UE dedicated signaling.

Existing technology supports several specialized radio access approaches which are optimized for IoT use cases or for reduced complexity type of devices. This disclosure provides methods and apparatuses to reduce the device cost, to increase the achievable battery life or standby times, to support small form factors, and/or to deploy such devices in deep indoor environments when compared to devices such as using a smartphone form factor. For example, IoT or reduced complexity type of devices can be based on LTE UE Category 1 or 1bis, based on LTE-M (or eMTC) or NB-IoT radio access, or such devices can use the NR Rel-17 Reduced Capability (REDCAP) feature.

There is need in 6G to replace the existing eMTC and NB-IoT based radio access approaches. For example, co-deployment of NB-IoT in a carrier or a band can result in narrowband RF coexistence issues due to the need to cope with the more challenging network amplifier and filtering design resulting from the NB-IoT in-band narrowband interferer, i.e., using 180 kHz or 1 PRB according to the NB-IoT channelization. For example, eMTC and LTE UE category 1/1bis devices have been widely implemented and are successfully deployed but a need arises to substitute these types of devices due to the need to phase out LTE radio access for spectrum re-farming to 5G NR and the advent of 6G.

There is need in 6G to improve upon several observed shortcomings observed with existing IoT or REDCAP type of devices in commercial network deployments which can negatively impact the achievable cell throughput, spectral efficiency and coverage. For example, using the Rel-17 NR REDCAP feature, the RF bandwidth of the REDCAP device is limited to 20 MHz or less. It can then become cumbersome to spread the REDCAP devices inside and across the often larger NR carrier bandwidth. One reason is the need to support initial access for REDCAP devices based on the Rel-15 NR initial BWP which then may result in subsequent assignment of REDCAP devices to other BWPs in the NR carrier BW for SSBs monitoring. For example, REDCAP devices can fracture the available contiguous DL or UL scheduling bandwidth for normal, i.e., non-IoT or non-REDCAP devices in the deployment which can reduce the cell aggregate throughput or spectral efficiency. For example, existing technology based on eMTC radio access or using Rel-17 REDCAP devices can result in the need to configure device or device class specific cell access barring per cell in the deployment which can result in higher network complexity or can result in inconsistent coverage for such devices. One reason is a reduced DL coverage observed for single antenna devices in some bands in the deployment. In one example, existing network deployments may need to separately enable or disable cell level access barring for single Rx antenna (1-Rx) or dual Rx antenna (2-Rx) eMTC or REDCAP devices, or for Rel-17 NR REDCAP devices using 20 MHz max Tx/Tx bandwidth, or for Rel-18 NR REDCAP devices using 20 MHz Tx/Rx bandwidth but limited to maximum 25 PRB baseband processing capability within their 20 MHz RF bandwidth.

There is need in 6G to improve the support for features such as network energy savings (NES), or massive MIMO, or AI/ML when compared to existing technology based on 4G/LTE or 5G/NR radio access. Accordingly, radio access for IoT or reduced complexity type of devices using 6G radio access may need to account for efficient support of the NES feature for which existing technology based on LTE UE Category 1/1bis, or eMTC, or NB-IoT, or NR REDCAP offer only very limited or no support. For example, existing IoT devices such as based on NB-IoT may implement and use the features such as Power-Saving mode (PSM) or Cellular-over-IoT (CIoT) wherein the radio access network cannot control itself or adjust the timing of the UL transmissions from the UE because parts of the protocol may reside and operate in the core network (CN). For example, some device classes based on NB-IoT may not support DL receptions or UL transmissions in RRC_CONNECTED mode. The existing Rel-18 NR NES feature based on Cell DTX/DRX patterns defined for RRC_CONNECTED mode then may not allow to control the Tx/Rx activity of such IoT devices operating in RRC_IDLE/INACTIVE modes.

When implementing procedures for UEs with reduced capabilities, or for resource allocation in frequency domain or in time domain, or for bandwidth part operation in a wireless communication system, several issues related to limitations and drawbacks of existing technology need to be overcome in order to increase the UE or cell throughput rate, to improve the DL or UL coverage, to reduce the UE or BS modem complexity, or to improve system operation according to channel conditions.

The UE supporting 6G radio access according to the 6G reduced capability (RC) feature (i.e., the 6G RC UE) may implement a cost reduction technique. For example, the 6G RC UE may operate according to a limited or restricted maximum RF bandwidth when compared to the 6G carrier BW, such as 3 or 5 MHz for use cases such as IoT or a maximum RF bandwidth such as 20 MHz for reduced complexity UE implementation. Without loss of generality and for illustration purposes, an exemplary maximum RF bandwidth of 5 MHz is assumed by some examples, but similar implementations can be extended to other maximum RF bandwidths such as 1.4 MHz or 3 MHz, or similar implementations can be extended to combinations of a maximum RF bandwidth such as 20 MHz in the DL and a limited or restricted maximum BB processing capability such as 5 MHz or 25 RBs in the DL within the maximum RF bandwidth. For example, a maximum RF bandwidth in the DL such as 20 MHz may be supported by a RC UE in combination with a maximum RF bandwidth in the UL such as 5 MHz. The limited or restricted maximum 5 MHz BW transmission or reception capability by the UE in the DL or UL does not allow to capture sufficient frequency diversity in a number of propagation environments and deployment cases. For example, most frequency diversity gains can often be captured already within 20 MHz bandwidth. Using the limited or restricted 5 MHz BW can then result in some 2-3 dB worse link performance. An additional DL link penalty may be incurred by 6G RC UEs due to single Rx antenna reception in some bands.

A large number of UEs supporting IoT use cases may need to operate in a cell. For example, the 6G RC UE may implement a limited or restricted maximum 5 MHz BW for receptions or transmissions with UE support of one configured BWP as by the Rel-15 NR baseline UE capability. A consequence is that load balancing across a wider carrier bandwidth would become more complex than already observed for the Rel-17 NR REDCAP UEs based on a maximum 20 MHz RF bandwidth. In the UL, the 6G RC devices with maximum 5 MHz BW capability may further fracture the available contiguous UL scheduling BW. This would greatly reduce the UL cell TP/SE for the medium-good SINR UEs using PUSCH resource allocation type 1 (w/wo RBG grouping). In the DL, 6G RC devices should ideally not reside within the same 5 MHz bandwidth segment. There is need to spread the UEs across the entire DL scheduling BW across the carrier BW to benefit from multiplexing gains during scheduling. For a same carrier bandwidth, using 6G RC UEs with 3 MHz RF bandwidth, 6-7 times more DL BWPs with a CD-SSB, or with an NCD-SSB, each may then be needed when compared to using Rel-17 REDCAP UEs with 20 MHz RF bandwidth.

UE support of multiple BWPs according to existing Rel-15 NR principles may result in a corresponding increase of the UE modem complexity. This is undesirable for IoT or reduced complexity UEs. For example, in FDD band n66 (UL 1710-1780 MHz, DL 2110-2200 MHz) with a carrier BW up to 40 MHz, if the 6G RC UE can support 1 active BWP and 4 configured BWPs with fast switching, around 12/40 MHz or 30% of the carrier BW are then schedulable for the 6G RC UE at the expense of increased UE modem complexity. For example, in TDD band n41 (2600 MHz) with a carrier BW up to 100 MHz, the 6G RC UE would then need to support up to 8 configured BWPs with fast switching such that 24/100 MHz or 24% of the carrier BW are schedulable for the 6G RC UE. However, 8 configured BWPs per UE are not supported by Rel-15 NR, and the associated UE modem complexity would further increase.

6G RC UEs supporting a maximum RF bandwidth such as 3 or 5 MHz for IoT use cases or such as 20 MHz for reduced complexity UE implementations with or without a restricted or limited baseband processing capability such as 25 RBs or 5 MHz within the maximum RF bandwidth may need to coexist in the 6G carrier or band together with normal or high-end 6G devices such as using a smartphone or a fixed wireless access CPE form factor. Furthermore, co-deployment/coexistence may also be needed with NR or LTE UEs in the carrier or band. For example, similar to Rel-15 NR principles, normal or high-end 6G UEs may support the full mandatory set of UE channel bandwidths up to the nominal carrier BW defined for the operating band. For example, different from Rel-15 NR principles, such 6G UEs may support a larger UE channel bandwidth than the IoT or reduced complexity UEs in the operating band, e.g., larger than 20 MHz RF bandwidth, without necessarily supporting the maximum possible UE channel bandwidth defined for the band. For example, coexistence or co-scheduling of different RF bandwidth capability devices including the 6G RC UEs in the carrier BW should not be penalized by trunking effects such as partially occupied or unusable RBGs or RBs. This would result in a reduced maximum DL or UL throughput or cell spectral efficiency. For example, it may be desirable to support a contiguous reception bandwidth from the perspective of UE modem design. For example, supporting wideband PRG reception according to existing Rel-15 NR when the 6G RC UEs fracture a contiguous DL reception BW for the normal UE may result in a doubling of the channel estimation or Rx filtering complexity for some UE implementations. For example, the coexistence or co-scheduling of different RF bandwidth capability devices in the carrier bandwidth should allow that the frequency hopping behavior of 6G RC UEs should be compatible with normal or high-end UEs. A subsequent hop into another maximum 3 MHz bandwidth part or into another subband within the carrier bandwidth should not collide or conflict with the allocations of the DL or UL signals or channels of UEs supporting a larger UE channel bandwidth.

Therefore, there is need to support a mode of operation for the 6G RC UEs wherein an effective or a resulting transmission or reception bandwidth (e.g., across multiple slots) in a carrier bandwidth which is larger than a limited or restricted instantaneous transmission or reception bandwidth of the device (e.g., within a slot or on a symbol) can be enabled. There is need to support a mode of operation for the 6G RC UEs wherein DL or UL scheduling within some or most of the carrier BW is enabled despite a limitation or restriction to an instantaneous maximum 3 or 5 MHz bandwidth in a reception or transmission occasion. For example, the 6G RC UE should remain schedulable within >20% of the DL carrier BW despite not exceeding a maximum 3 or 5 MHz BW in a reception or transmission occasion. Therefore, there is a need to support methods and procedures for resource allocation of 6G UEs such that a frequency-domain allocation granularity such as an RBG size, a PRG or REG size or a frequency hopping behavior can be compatible between the 6G RC UEs and the normal UEs when operating in the carrier bandwidth.

In one embodiment of the present disclosure, the BS indicates to a 6G UE the BWPs or subbands of the 6G carrier BW in which the 6G reduced complexity or reduced capability (RC) UE may receive or transmit. For example, the normal UE can receive a higher layer configuration by RRC and/or an indication by DCI or MAC-CE wherein the BWPs or subbands corresponding to possible receptions or transmissions by the RC UE in the 6G carrier BW are identified.

In one embodiment, a UE is provided with information to determine whether a transmission or a reception in a BWP or subband corresponding to a reduced bandwidth transmission or reception in a carrier bandwidth is allowed or dis-allowed, or enabled or disabled.

In one example, the information provided to a UE such as a non-RC UE whether a transmission or reception in a BWP or a subband of the carrier bandwidth is allowed or enabled, or dis-allowed or disabled, may correspond to a BWP or subband which is associated with a possible or expected transmission or reception occasion for a RC UE. When a set of BWPs or of subbands corresponding to the reduced bandwidth transmission or reception occasions in the carrier BW is provided to the UE, an indication to the UE if a transmission or reception is allowed or enabled, or dis-allowed or enabled may be provided per BWP or per subband, or for a group of BWPs or of subbands. For example, when a set of size N_{BWP} or N_{SB} of BWPs or of subbands is provided to the UE, a transmission or reception behavior corresponding to a subset of size M≤N_{BWP} or M≤N_{SB} may be indicated to the UE.

In the example, a UE such as a RC UE is provided with a BWP or a subband configuration corresponding to a reduced bandwidth transmission or reception in a carrier bandwidth. The BWP or a subband configuration may be comprised of a set of BWPs or of subbands. For example, a DL reception by the UE may be limited or restricted in a DL BWP or a DL subband corresponding to a reduced bandwidth reception. If a DL reception is limited or restricted, the UE does not receive a DL signal or channel outside of a DL BWP or DL subband corresponding to a reduced bandwidth reception. For example, the UE determines a set of DL usable RBs for DL reception based on the DL BWP or DL subband configuration such as by including DL RBs or RBGs which are fully and/or partially contained within a DL BWP or DL subband of the provided configuration. For example, an UL transmission by the UE may be limited or restricted to an UL BWP or UL subband corresponding to reduced bandwidth transmission. If an UL transmission is limited or restricted, the UE does not transmit an UL signal or channel outside of an UL BWP or UL subband corresponding to reduced bandwidth transmission. For example, the UE determines a set of UL usable RBs for UL transmission based on the UL BWP or UL subband configuration such as by including UL RBs or RBGs which are fully and/or partially contained within an UL BWP or UL subband of the provided configuration.

In the example, a UE such as a non-RC UE is provided with a BWP or a subband configuration in a carrier bandwidth wherein the BWP or subband configuration may correspond to a transmission or reception occasion for a RC UE. A BWP or a subband configuration may be comprised of a set of BWPs or of subbands. For example, a DL reception by the UE may be limited or restricted in the carrier bandwidth. If a DL reception is limited or restricted, the UE does not receive a DL signal or channel inside a DL BWP or DL subband corresponding to a reduced bandwidth reception, i.e., corresponding to a DL BWP or DL subband wherein a transmission from the BS to a RC UE may occur. The UE may be scheduled or configured for a DL reception in frequency-domain resources of the DL carrier bandwidth outside of a DL BWP or DL subband corresponding to reduced bandwidth reception. For example, the UE determines a set of DL usable RBs for DL reception based on the DL BWP or DL subband configuration such as by excluding DL RBs or RBGs which are fully and/or partially contained within a DL BWP or DL subband of the provided configuration. For example, a DL reception of the UE may be further restricted in the DL carrier bandwidth by the active DL BWP of the UE. For example, an UL transmission from the UE may be limited or restricted in the carrier bandwidth. If an UL transmission is limited or restricted, the UE does not transmit an UL signal or channel inside an UL BWP or UL subband corresponding to a reduced bandwidth transmission, i.e., corresponding to an UL BWP or UL subband wherein a reception by the BS from a RC UE may occur. The UE may be scheduled or configured for an UL transmission in frequency-domain resources of the UL carrier bandwidth outside of an UL BWP or UL subband corresponding to reduced bandwidth transmission. For example, the UE determines a set of UL usable RBs for UL reception based on the UL BWP or UL subband configuration such as by excluding UL RBs or RBGs which are fully and/or partially contained within an UL BWP or UL subband of the provided configuration. For example, an UL transmission from the UE may be further restricted in the UL carrier bandwidth by the active UL BWP of the UE.

This disclosure provides an increased UE throughput for receptions by non-RC UE. Reduced bandwidth devices in the DL carrier bandwidth may implement a limited support for DL MIMO operation or for CSI reporting, or may use single antenna DL reception in a small instantaneous reception bandwidth such as 3 or 5 MHz. For example, when the BWP or subband configuration corresponding to reduced bandwidth reception in a carrier bandwidth is known by the non-RC UE, a DL signal such as a CSI-RS resource set supporting a larger number of ports or a larger number of spatial layers for measurement and reporting by a non-RC UE may then be configured or indicated with fewer constraints such as a minimum contiguous CSI-RS resource bandwidth in frequency-domain. For example, a CSI report based on CSI-RS resources outside and in-between the DL BWPs or DL subbands corresponding to reduced bandwidth receptions can be enabled. This can increase the DL scheduling efficiency in the cell due to an improved DL MIMO performance for non-RC UEs.

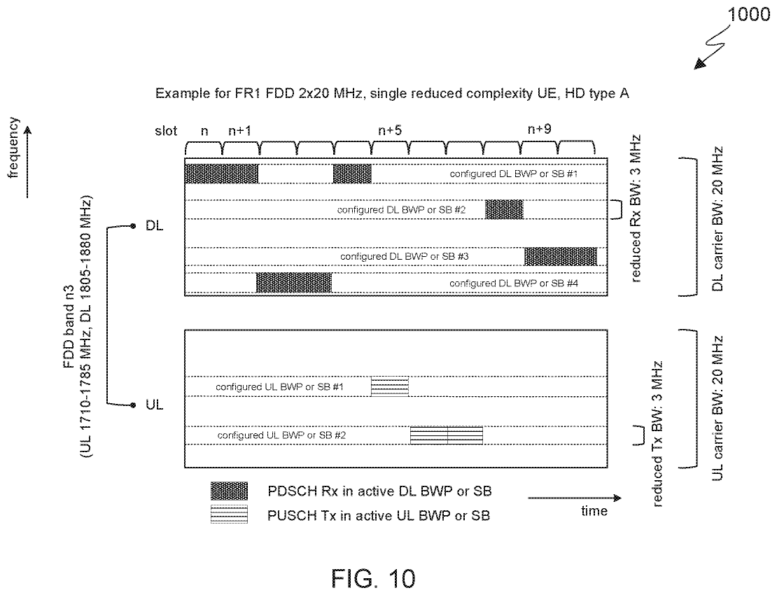

FIG. 10 illustrates an example timeline 1000 of a reception or transmission sequence with frequency hopping across BWPs or subbands by a reduced complexity UE according to embodiments of the present disclosure. More particularly, FIG. 10 illustrates an example of a BWP or subband configuration corresponding to a reduced bandwidth reception or transmission in a carrier bandwidth. For example, the BWP or subband configuration can be implemented by BS 102 of FIG. 1 and any of the UEs 111-116 of FIG. 1. This example is for illustration only and other embodiments can be used without departing from the scope of the present disclosure.

The RC UE is provided with a number of configured DL BWPs or SBs such as N_{BWP,DL}=4 for DL receptions by a reduced complexity UE in a DL carrier BW. The RC UE receives a PDSCH in an active DL BWP or SB from the set N_{BWP,DL} in a slot n. DL receptions of a later PDSCH may occur in a same or another DL BWP or SB from the set N_{BWP,DL} in a later slot such as n+1 or n+2. For example, the active DL BWP or SB remains the same for DL reception in slot n+1 but is switched according to the frequency hopping for the RC UE in slot n+2 and n+3. The UE is provided with a number of configured UL BWPs or SBs such as N_{BWP,UL}=2 for UL transmissions by a reduced complexity UE in a UL carrier BW. The RC UE transmits a PUSCH in an active UL BWP or SB from the set N_{BWP,UL} in a slot n+5. UL transmissions of a later PUSCH may occur in a same or another UL BWP or SB from the set N_{BWP,UL} in a later slot such as n+6 or n+7. For example, the active UL BWP or SB is switched according to the frequency hopping pattern for the RC UE for UL transmission in slot n+6 but remains the same in slot n+7. In the example, the RC uses half-duplex type A and switches from DL receptions to UL transmissions in a switching time such as <140 μs.

The non-RC UE is provided by the BS with the BWP or SB configuration corresponding to the set N_{BWP,DL} or N_{BWP,UL} for reduced bandwidth transmission or reception in the carrier BW. For example, the non-RC UE may be indicated by the BS that a transmission or reception in a BWP or a subband from the set N_{BWP,DL} or N_{BWP,UL} is disabled or disallowed. The non-RC UE then further determines a reception or transmission BW based on the DL or UL usable RBs by excluding the RBs or RBGs corresponding to the indicated BWPs or subbands in the carrier BW. For example, the non-RC UE may be provided by the BS with a subset of size M<N_{BWP,DL} and DL receptions in the M BWPs or subbands of the DL carrier BW are disabled or dis-allowed but a DL receptions in the remaining N_{BWP,DL}−M BWPs or subbands of the DL carrier BW are enabled or allowed.

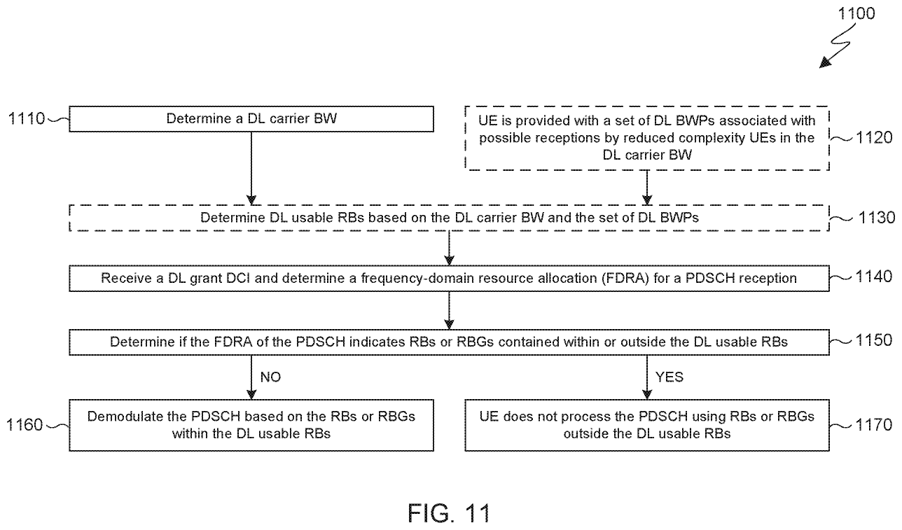

FIG. 11 illustrates an example method 1100 for determination of DL usable RBs in a DL carrier BW according to embodiments of the present disclosure. The method 1100 of FIG. 11 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1100 is for illustration only and other embodiments can be used without departing from the scope of the present disclosure.

The method 1100 begins with the UE determining a DL carrier BW (1110). Optionally, the UE is provided with a set of DL BWPs associated with possible receptions by reduced complexity UEs in the DL carrier BW (1120). Then, optionally, the UE determines DL usable RBs based on the DL carrier BW and the set of DL BWPs (1130). The UE then receives a DL grant DCI and determines a frequency-domain resource allocation (FDRA) for a PDSCH reception (1140). The UE then determines if the FDRA of the PDSCH indicates RBs or RBGs contained within or outside the DL usable RBs (1150). If the FDRA of the PDSCH does not indicate RBs or RBGs contained within or outside the DL usable RBs, then the UE demodulates the PDSCH based on the RBs or RBGs within the DL usable RBs (1160). If the FDRA of the PDSCH does indicate RBs or RBGs contained within or outside the DL usable RBs, then the UE does not process the PDSCH using RBs or RBGs outside the DL usable RBs (1170).

Although FIG. 11 illustrates one example method 1100 of the actions taken by the UE, various changes may be made to FIG. 11. For example, while shown as a series of steps, various steps in FIG. 11 could overlap, occur in parallel, occur in a different order, or occur any number of times.

In a variation of the above embodiment, the BS indicates to a 6G UE the narrowbands or RBs in the 6G carrier BW in which eMTC or NB-IoT UEs may receive or transmit. For example, the 6G UE can receive a higher layer configuration by RRC and/or an indication by DCI or MAC-CE wherein the narrowbands or RBs corresponding to possible receptions or transmissions by an eMTC or NB-IoT UE in the 6G carrier BW are identified.

In one embodiment, a UE is provided with information to determine whether an RB or a set of RBs in a carrier bandwidth corresponds to a reception or transmission occasion for an NB-IoT UE, or a narrowband or a set of narrowbands for an eMTC UE. A UE may be further provided with information whether a transmission or reception in a carrier bandwidth in the indicated RB or set of RBs or narrowband or set of narrowbands is allowed or dis-allowed, or enabled or disabled for the UE.

In one example, the information provided to the UE whether a transmission or reception in a carrier bandwidth is allowed or enabled, or dis-allowed or disabled, may correspond to a narrowband such as defined in [REF 7] which is associated with a possible or expected transmission or reception occasion for an eMTC or an NB-IoT UE. When a set of narrowbands corresponding to a reduced bandwidth transmission or reception is provided to the UE, an indication if a transmission or reception is allowed or enabled, or dis-allowed or enabled may be provided for a set of RBs or RBGs in the carrier bandwidth.

In the example, a UE such as a non-RC UE is provided with a set of narrowbands in a carrier bandwidth wherein a narrowband may correspond to a transmission or reception occasion of an eMTC or an NB-IoT UE. A narrowband configuration may be comprised of a set of narrowbands with one or more narrowbands. For example, an eMTC UE of category M1 or M2, e.g., based on 1.4 MHz or 6 RBs for 15 kHz SCS may transmit or receive using one narrowband in a transmission or reception occasion and hop to another narrowband for a later transmission or reception. For example, an eMTC UE of category M3 or M4, e.g., based on 1.4 MHz or 5 RBs for 15 kHz SCS may transmit or receive using one narrowband in a transmission or reception occasion and hop to another narrowband for a later transmission or reception. A set of narrowbands may then correspond to one of the narrowbands or a set of narrowband across which a frequency hopping of eMTC UEs can operate. Additional parameters associated with the transmission or reception behavior of an eMTC UE may be provided as part of the narrowband configuration. For example, an SFN offset or delta value with respect to a difference between a DL transmission timing of eMTC transmissions and a DL transmission timing of 6G radio access transmissions may be provided to determine a hopping timing. For example, a DL reception by the UE may be limited or restricted in the carrier bandwidth. If a DL reception is limited or restricted, the UE does not receive a DL signal or channel inside a narrowband corresponding to eMTC reception, i.e., corresponding to a narrowband wherein a transmission from the BS to an eMTC or NB-IoT may occur. The UE may be scheduled or configured for a DL reception in frequency-domain resources of the DL carrier bandwidth outside of a narrowband corresponding to eMTC or NB-IoT reception. For example, the UE determines a set of DL usable RBs for DL reception based on the narrowband configuration such as by excluding DL RBs or RBGs which are fully and/or partially contained within a narrowband of the provided configuration. For example, a DL reception of the UE may be further restricted in the DL carrier bandwidth by the active DL BWP of the UE. For example, an UL transmission from the UE may be limited or restricted in the carrier bandwidth. If an UL transmission is limited or restricted, the UE does not transmit an UL signal or channel inside a narrowband corresponding to an eMTC or NB-IoT transmission, i.e., corresponding to a narrowband wherein a reception by the BS from an eMTC or NB-IoT UE may occur. The UE may be scheduled or configured for an UL transmission in frequency-domain resources of the UL carrier bandwidth outside of a narrowband corresponding to eMTC or NB-IoT transmission. For example, the UE determines a set of UL usable RBs for UL reception based on the narrowband configuration such as by excluding UL RBs or RBGs which are fully and/or partially contained within a narrowband of the provided configuration. For example, an UL transmission from the UE may be further restricted in the UL carrier bandwidth by the active UL BWP of the UE.

This disclosure provides coexistence and co-deployment of 6G radio access in carrier of a band where LTE-M UEs according to eMTC or NB-IoT may be present. For example, eMTC UEs in a UL carrier bandwidth may implement a limited UL transmit power such as 20 or 14 dBm. Selectively enabling or disabling UL reception from 6G UEs in the UL narrowband can then avoid a need to implement joint link adaptation for UL scheduling of 6G and eMTC UEs in the BS.

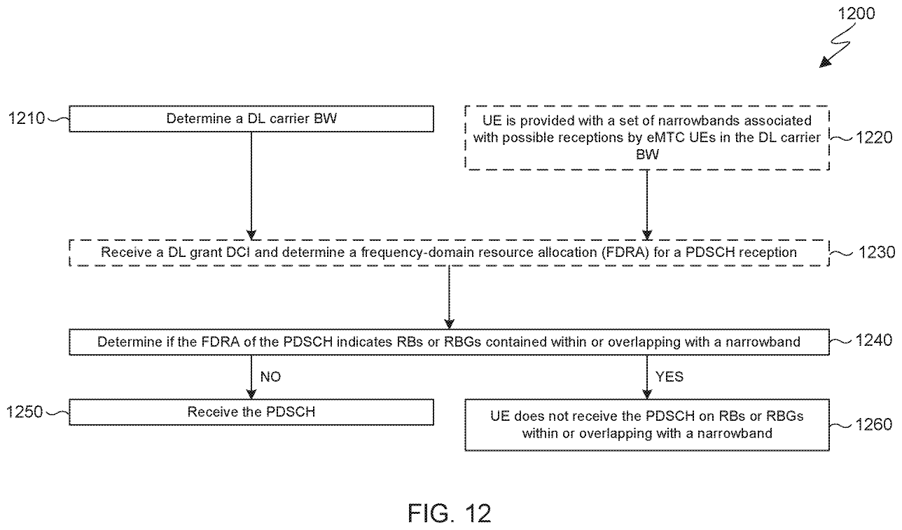

FIG. 12 illustrates an example method 1200 for determination of DL usable RBs based on an enhanced machine-type communication (eMTC) narrowband in a DL carrier BW according to embodiments of the present disclosure. The method 1200 of FIG. 12 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1200 is for illustration only and other embodiments can be used without departing from the scope of the present disclosure.

The method 1200 begins with the UE determining a DL carrier BW (1210). Optionally, the UE is provided with a set of narrowbands associated with possible receptions by eMTC UEs in the DL carrier BW (1220). The UE then receives a DL grant DCI and determines a frequency-domain resource allocation (FDRA) for a PDSCH reception (1230). Then, optionally, the UE determines if the FDRA of the PDSCH indicates RBs or RBGs contained within or overlapping with a narrowband (1240). If the FDRA of the PDSCH does not indicate RBs or RBGs contained within or overlapping with a narrowband, then the UE receives the PDSCH (1250). If the FDRA of the PDSCH does indicate RBs or RBGs contained within or overlapping with a narrowband, then, optionally, the UE does not receive the PDSCH on RBs or RBGs within or overlapping with a narrowband (1260).

Although FIG. 12 illustrates one example method 1200 of the actions taken by the UE, various changes may be made to FIG. 12. For example, while shown as a series of steps, various steps in FIG. 12 could overlap, occur in parallel, occur in a different order, or occur any number of times.

In one embodiment of the present disclosure, the BS indicates to a 6G UE a BWP or a subband in the 6G carrier BW in which the 6G reduced complexity or reduced capability (RC) UE, or the BS indicates to a 6G UE a narrowband or RBs in the 6G carrier BW in which eMTC or NB-IoT UEs may receive or transmit, and the BWP or subband is associated with a type, e.g., DL, or UL, or flexible, or reserved, or RC, or non-RC.

The indicated BWP or subband or narrowband or RBs can be associated with a type such as a possible transmission direction such as DL, or UL, or flexible, or reserved. For example, a BWP or subband of flexible type may correspond to a BWP or subband in which DL receptions to or UL transmissions from the RC UE may be scheduled or configured. For example, a BWP or subband of reserved type may correspond to a BWP or subband in which the UE does not assume a transmission or reception direction.

The indicated BWP or subband or narrowband or RBs can be associated with a type such as a device type or device category for which a reception or a transmission is allowed or dis-allowed in a BWP or a subband. For example, a BWP or subband of type RC UE may correspond to a BWP or subband in which DL receptions to or UL transmissions from the RC UE may be scheduled or configured. For example, a BWP or subband of type non-RC UE may correspond to a BWP or subband in which DL receptions to or UL transmissions from a UE supporting the maximum UE channel BW in the band may be scheduled or configured.

In one embodiment, a UE is provided with information to determine whether a transmission or a reception in a BWP or subband corresponding to a reduced bandwidth transmission or reception in a carrier bandwidth is allowed or dis-allowed, or enabled or disabled wherein the BWP or the subband is associated with a BWP or subband type such as DL, or UL, or flexible, or reserved, or RC, or non-RC.

In one example, the information provided to the UE whether a transmission or reception in a BWP or a subband in the carrier bandwidth is allowed or enabled, or dis-allowed or disabled, may correspond to a flexible BWP or subband which is associated with a possible or expected transmission or reception occasion for a non-RC UE or for a RC UE. When a set of BWPs or of subbands corresponding to a reduced bandwidth transmission or reception is provided to the UE, an indication if a BWP or subband corresponds to flexible type may be provided per BWP or per subband, or for a group of BWPs or of subbands. For example, when a set of size N_{BWP} or N_{SB} of BWPs or of subbands is provided to the UE, a transmission or reception behavior of flexible type corresponding to a subset of size M≤N_{BWP} or M≤N_{SB} may be indicated to the UE.

In the example, a UE such as a RC UE is provided with a BWP or a subband configuration corresponding to a reduced bandwidth transmission or reception in a carrier bandwidth wherein a BWP or a subband is of a flexible type. A possible or expected transmission or reception occasion in the flexible BWP or subband may be scheduled, or configured, or indicated for a non-RC UE or for a RC UE. The BWP or a subband configuration may be comprised of a set of BWPs or of subbands wherein one or more of the BWPs or subbands correspond to the flexible type. For example, a DL reception by the UE may be limited or restricted in a DL BWP or a DL subband corresponding to a reduced bandwidth reception including a DL BWP or DL subband of flexible type. If a DL reception is limited or restricted, the UE does not receive a DL signal or channel outside of a DL BWP or DL subband corresponding to a reduced bandwidth reception including the DL BWP or DL subband of flexible type. For example, the UE determines a set of DL usable RBs for DL reception based on the DL BWP or DL subband configuration such as by including DL RBs or RBGs which are fully and/or partially contained within a DL BWP or DL subband of the provided configuration including a DL BWP or DL subband of flexible type. For example, an UL transmission by the UE may be limited or restricted to an UL BWP or UL subband corresponding to reduced bandwidth transmission including an UL BWP or UL subband of flexible type. If an UL transmission is limited or restricted, the UE does not transmit an UL signal or channel outside of an UL BWP or UL subband including an UL BWP or UL subband of flexible type corresponding to reduced bandwidth transmission. For example, the UE determines a set of UL usable RBs for UL transmission based on the UL BWP or UL subband configuration such as by including UL RBs or RBGs which are fully and/or partially contained within an UL BWP or UL subband of the provided configuration including an UL BWP or UL subband of flexible type.

In the example, a UE such as a non-RC UE is provided with a BWP or a subband configuration corresponding to a reduced bandwidth transmission or reception in a carrier bandwidth wherein a BWP or a subband is of a flexible type. A possible or expected transmission or reception occasion in the flexible BWP or subband may be scheduled, or configured, or indicated for a non-RC UE or for a RC UE. A BWP or a subband configuration may be comprised of a set of BWPs or of subbands. For example, a DL reception by the UE may be limited or restricted in the carrier bandwidth. If a DL reception is limited or restricted, the UE does not receive a DL signal or channel in a DL BWP or DL subband corresponding to a reduced bandwidth reception, but the UE may receive a DL signal or channel in DL BWP or DL subband of flexible type. The UE may be scheduled or configured for a DL reception in frequency-domain resources of the DL carrier bandwidth outside of a DL BWP or DL subband corresponding to reduced bandwidth reception and in a DL BWP or DL subband of flexible type. For example, the UE determines a set of DL usable RBs for DL reception based on the DL BWP or DL subband configuration such as by excluding DL RBs or RBGs which are fully and/or partially contained within a DL BWP or DL subband of the provided configuration but includes the DL RBs or RBGs of a DL BWP or DL subband of flexible type. For example, an UL transmission from the UE may be further restricted in the UL carrier bandwidth by the active UL BWP of the UE. For example, an UL transmission from the UE may be limited or restricted in the carrier bandwidth. If an UL transmission is limited or restricted, the UE does not transmit an UL signal or channel inside an UL BWP or UL subband corresponding to a reduced bandwidth transmission, but the UE may transmit an UL signal or channel in an UL BWP or UL subband of flexible type. The UE may be scheduled or configured for an UL transmission in frequency-domain resources of the UL carrier bandwidth outside of an UL BWP or UL subband corresponding to reduced bandwidth transmission and in an UL BWP or UL subband of flexible type. For example, the UE determines a set of UL usable RBs for UL reception based on the UL BWP or UL subband configuration such as by excluding UL RBs or RBGs which are fully and/or partially contained within an UL BWP or UL subband of the provided configuration and including the UL RBs or RBGs of an UL BWP or UL subband of flexible type. For example, an UL transmission from the UE may be further restricted in the UL carrier bandwidth by the active UL BWP of the UE.

This disclosure provides an increased cell aggregate throughput. Using flexible BWPs or subbands in the carrier bandwidth which can be scheduled or assigned to any type of UE can avoid a reduced DL spectral efficiency resulting from bandwidth segmentation or resource partitioning penalty such as in a case of smaller available carrier bandwidth of 20 or 40 MHz in a band.

As can be seen by someone skilled in the art, similar implementations with respect to the UE determination of usable RBs can be applied when the information provided to the UE whether a transmission or reception in a BWP or a subband in the carrier bandwidth is allowed or enabled, or dis-allowed or disabled, is indicated to the UE as a contiguous or non-contiguous reception or transmission bandwidth in a carrier bandwidth in which a transmission to or reception from a RC UE is not expected.

In one embodiment of the present disclosure, the BS indicates to a 6G UE a frequency-domain location of a guard RB or guard band, e.g., associated with possible UL transmission from RC UEs. For example, a guard RB or guard band can be configured for or indicated to the RC UE inside or outside the UL BWP or the UL subband in the 6G carrier BW in which the RC UE may transmit.

In one embodiment, a UE is provided with information to determine a frequency-domain location of a guard RB or a guard band corresponding to a reduced bandwidth transmission in a carrier bandwidth. A frequency-domain location of a guard RB or guard band may be located inside or outside the BWP or the subband corresponding to reduced bandwidth transmission.

For example, the information provided to the UE and associated with a guard band may correspond to a number of RBs, or a set of guard RBs, or a number of subcarriers in which an UL transmission from a RC UE may not occur. For example, the information provided to the UE and associated with a guard band may correspond to a location type such as within or outside a BWP or subband corresponding to UL transmission occasions of a RC UE. For example, when a number of RBs, or a set of guard RBs corresponding to a reduced bandwidth transmission or reception is provided to the UE, an indication associated with a frequency-domain location of one or multiple guard bands may be provided per BWP or per subband, or for a group of BWPs or of subbands. A guard RB associated with a reduced bandwidth transmission may be located within a BWP or subband corresponding to the reduced bandwidth transmission or reception or may be located outside such as adjacent or next to such a BWP or subband.

In the example, a UE such as a RC UE is provided with a BWP or a subband configuration corresponding to a reduced bandwidth transmission in the UL carrier bandwidth. For example, an UL transmission by the UE may be limited or restricted to an UL BWP or UL subband corresponding to reduced bandwidth transmission. If an UL transmission is limited or restricted, and when a set of guard RBs is provided outside an UL BWP or UL subband, the UE does not transmit an UL signal or channel outside of an UL BWP or UL subband corresponding to reduced bandwidth transmission. For example, the UE determines a set of UL usable RBs for UL transmission based on the UL BWP or UL subband configuration such as by including UL RBs or RBGs which are fully and/or partially contained within an UL BWP or UL subband of the provided configuration. If an UL transmission is limited or restricted, and when a set of guard RBs is provided within an UL BWP or UL subband, the UE does not transmit an UL signal or channel outside of an UL BWP or UL subband corresponding to reduced bandwidth transmission, and the UE does not transmit an UL signal or channel in an RB of the guard band. For example, the UE determines a set of UL usable RBs for UL transmission based on the UL BWP or UL subband configuration such as by including UL RBs or RBGs which are fully and/or partially contained within an UL BWP or UL subband and excluding an RB of the guard band according to the provided configuration.

In the example, a UE such as a non-RC UE is provided with a BWP or a subband configuration in an UL carrier bandwidth wherein the BWP or subband configuration may correspond to a transmission occasion of a RC UE. For example, an UL transmission from the UE may be limited or restricted in the UL carrier bandwidth. If an UL transmission is limited or restricted, and when a set of guard RBs is provided outside an UL BWP or UL subband, the UE does not transmit an UL signal or channel inside an UL BWP or UL subband or in an RB of the guard band corresponding to a reduced bandwidth transmission. The UE may be scheduled or configured for an UL transmission in frequency-domain resources of the UL carrier bandwidth outside of an UL BWP or UL subband or the guard band corresponding to reduced bandwidth transmission. For example, the UE determines a set of UL usable RBs for UL transmission based on the UL BWP or UL subband configuration such as by excluding UL RBs or RBGs which are fully and/or partially contained within an UL BWP or UL subband or in an RB of the guard band of the provided configuration. For example, an UL transmission from the UE may be limited or restricted in the UL carrier bandwidth. If an UL transmission is limited or restricted, and when a set of guard RBs is provided within an UL BWP or UL subband, the UE does not transmit an UL signal or channel inside an UL BWP or UL subband including an RB of the guard band corresponding to a reduced bandwidth transmission. The UE may be scheduled or configured for an UL transmission in frequency-domain resources of the UL carrier bandwidth outside of an UL BWP or UL subband corresponding to reduced bandwidth transmission. For example, the UE determines a set of UL usable RBs for UL reception based on the UL BWP or UL subband configuration such as by excluding UL RBs or RBGs which are fully and/or partially contained within an UL BWP or UL subband or an RB of the guard band of the provided configuration. For example, an UL transmission from the UE may be further restricted in the UL carrier bandwidth by the active UL BWP of the UE.

This disclosure provides for support of enhanced UL coverage for a reduced complexity (or reduced capability) UE. Using a guard band for an UL BWP or for a UL subband associated with reduced bandwidth transmission, UL transmissions based on spectrum extensions schemes such as FDSS or based on a different waveform than an OFDM-based waveform may be employed to improve the UL link budget and extend the UL coverage for RC UEs.

In one embodiment of the present disclosure, the BS indicates to a 6G UE a limited part or region inside the 6G carrier BW, i.e., a virtual or reference BWP, inside of which the RC UE may be scheduled or configured to receive or transmit. The part or region inside the 6G carrier BW in which the RC UEs may transmit or receive may contain one or multiple BWPs or subbands associated with reduced bandwidth transmission or reception. For example, the virtual or reference BWP may correspond to a non-contiguous resource allocation in frequency-domain with respect to a common resource grid such as provided by the CRB grid. For example, the UE may be provided with a higher layer configuration by RRC and/or an indication by DCI or MAC-CE wherein the limited part or region corresponding to possible receptions or transmissions by an RC UE within the 6G carrier BW are identified. For example, based on the virtual or reference BWP, the RC UE can determine a field size of a frequency domain resource allocation field in a DL assignment or UL grant DCI. This can enable an indication of frequency-hopping across the BWPs or subbands associated with reduced bandwidth transmission or reception to the RC UE within the range of addressable RBs or RBGs provided by the virtual or reference BWP. For example, based on the virtual or reference BWP, the non-RC UE can determine different reception parameters such as a first and a second DL Rx EPRE value for inside and outside the limited part or region, respectively.

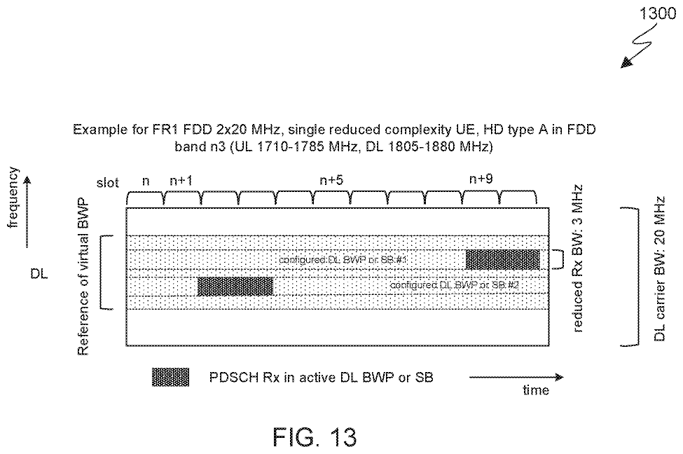

FIG. 13 illustrates an example timeline 1300 of a reception or transmission sequence with frequency hopping across BWPs or subbands by a reduced complexity UE using a reference BWP according to embodiments of the present disclosure. More particularly, FIG. 13 illustrates an example of a virtual or reference BWP configuration in a carrier bandwidth. For example, the virtual or reference BWP configuration can be implemented by BS 102 of FIG. 1. This example is for illustration only and other embodiments can be used without departing from the scope of the present disclosure.

The RC UE is provided with a number of configured DL BWPs or SBs such as N_{BWP,DL}=2 for DL receptions by a reduced complexity UE in a DL carrier BW. The RC UE is provided with a virtual or reference BWP of size N PRBs in the DL carrier BW comprising the set N_{BWP,DL}. The number N PRBs corresponding to the virtual or reference BWP determines a size of the FDRA field in a DL grant DCI. The RC UE receives a PDSCH in an active DL BWP or SB from the set N_{BWP,DL} in a slot n. DL receptions of a later PDSCH may occur in a same or another DL BWP or SB from the set N_{BWP,DL} in a later slot such as n+1 or n+2. For example, the active DL BWP or SB remains the same for DL reception in slot n+1 but is switched according to the frequency hopping for the RC UE in slot n+2 and n+3. The UE determines a frequency-hopping behavior based on the FDRA field in the DL grant DCI with respect to the virtual or reference BWP. For example, if a BWP indicator field is not configured or not available in the scheduling DCI, the RB indexing for downlink type 0 and type 1 resource allocation is determined within the UE's virtual or reference bandwidth part where RB numbering starts from the lowest RB in the virtual or reference BWP.

In one embodiment, a UE is provided with information associated with an operation based on a virtual or reference BWP in a carrier bandwidth to determine a frequency-domain allocation of a DL or UL signal or channel or to determine whether a transmission or a reception in a BWP or subband corresponding to a reduced bandwidth transmission or reception in a carrier bandwidth is allowed or dis-allowed, or enabled or disabled, or to determine a transmission or a reception parameter corresponding to a reduced bandwidth transmission or reception in a carrier bandwidth, wherein the virtual or reference BWP may correspond to a frequency-domain occupancy larger than the maximum RF bandwidth of a RC UE or smaller than the maximum UE channel BW in a band.

For example, the virtual or reference BWP may be associated with a frequency-domain resource allocation such as a number of RBs or a reference RB numbering corresponding to a range larger than a restricted or limited maximum reception or transmission bandwidth of the UE in a symbol or slot. For example, the virtual or reference BWP may comprise one or more BWPs or subbands provided to the UE for frequency-hopping in a carrier bandwidth. For example, the UE is provided with information for a virtual or a reference BWP to determine a frequency-domain occupancy of a DL subband, or of an UL subband, or for a reception or a transmission bandwidth, or a set or a size or a number of subbands, or a size of an RBG or a set of RBG sizes, or a bundling size such as a PRG bundling size, or a sub-carrier spacing. For example, the UE may operate according to a frequency hopping protocol based on a reference or a virtual BWP in a carrier bandwidth.

For example, a virtual or a reference BWP may be provided as information to a UE, i.e., a reference BWP of a UE can be configured, or indicated, or assigned to the UE, or can be tabulated by system operating specifications. A virtual or reference BWP may be determined by the UE. For example, a reference BWP may correspond to an actual BWP, i.e., one from a set of configured BWPs for UE receptions in a DL bandwidth, or one from a set of configured BWPs for UE transmissions in an UL bandwidth. For example, the UE can determine an active BWP of a serving cell to be a reference BWP. For example, a reference BWP may be selected by the UE from a set of configured BWPs. A reference BWP may correspond to an assumed or a virtual BWP configuration for which a parameter is provided to the UE. Based on the parameter the UE further determines a reception or transmission condition. For example, a virtual or a reference BWP may be determined by the UE based on a slot or symbol type based on a condition such as a condition corresponding to a transmission direction, i.e., DL or UL or Flexible, or NES or non-NES, or simultaneous Tx-Rx/SBFD or no simultaneous Tx-Rx/non-SBFD. A reference BWP for UE determination of a frequency-domain occupancy of DL subband, or of an UL subband or a guard band in the reception or transmission bandwidth may be provided to the UE or may be determined by the UE for a secondary cell or a secondary cell group, e.g., such as when operation according to reduced complexity or reduced capability is configured as SCell. For example, a virtual or reference BWP may be provided to the UE using a signaling described for UE operation in bandwidth parts (BWPs) such as indicating a common RB N_{BWP,ref}^{start}=O_{carrier}+RB_{start,ref} and a number of contiguous RBs N_{BWP,ref}^{size}=L_{RB,ref} with respect to a common RB grid.

For example, a frequency hopping operation on RBs or RBG or subbands may be defined based on a reference or virtual BWP. A reference or virtual BWP N_{BWP,ref} may be provided to the UE. A first set and a second set of RBs or RBGs or a first and a second subband S₁ and S₂ of the reference BWP N_{BWP,ref} which are available for hopping in frequency-domain may be provided to the UE. For example, a set S₁ and S₂ of RBs or RBGs or a first and a second subband of the reference BWP may be determined by the UE based on a frequency hopping parameter such as a number of hops or a hopping distance. The UE may hop across the set S₁ or S₂ of RBs or RBGs or the first and the second subband based on a subset from the set of RBs or RBGs or set of subbands in a reference or virtual BWP. For example, the RBs or RBGs or the subbands in the reference BWP across which a hopping pattern is determined may be evenly or unevenly spaced, i.e., separated in frequency-domain, or may have a same size or different sizes in frequency-domain. For example, separate values corresponding to a frequency hopping parameter may be provided to the UE for the DL receptions and UL transmissions, respectively.

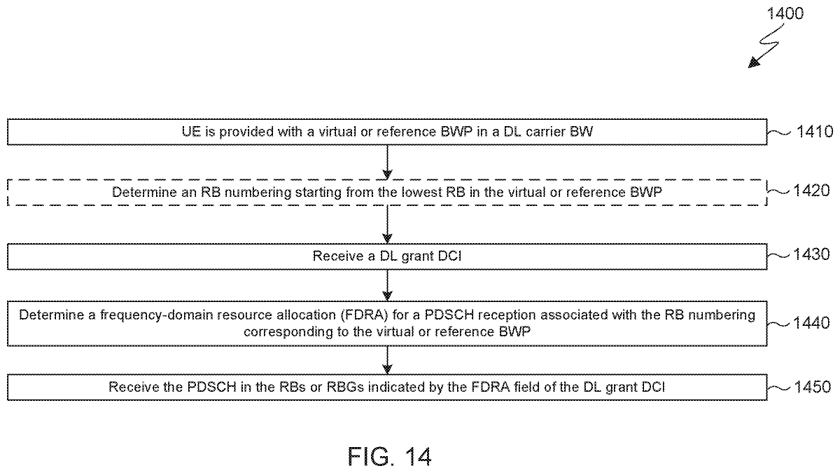

FIG. 14 illustrates an example method 1400 for PDSCH reception using frequency hopping within a reference BWP according to embodiments of the present disclosure. The method 1400 of FIG. 14 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1400 is for illustration only and other embodiments can be used without departing from the scope of the present disclosure.

The method 1400 begins with the UE being provided with a virtual or reference BWP in a DL carrier BW (1410). Then, optionally, the UE determines an RB numbering starting from the lowest RB in the virtual or reference BWP (1420). The UE then receives a DL grant DCI (1430). The UE then determines a frequency-domain resource allocation (FDRA) for a PDSCH reception associated with the RB numbering corresponding to the virtual or reference BWP (1440). The UE then receives the PDSCH in the RBs or RBGs indicated by the FDRA field of the DL grant DCI (1450).

Although FIG. 14 illustrates one example method 1400 of the actions taken by the UE, various changes may be made to FIG. 14. For example, while shown as a series of steps, various steps in FIG. 14 could overlap, occur in parallel, occur in a different order, or occur any number of times.

For example, UE is provided with a frequency-domain limit value determining a start or and end of the frequency-domain occupancy for reduced bandwidth transmissions or receptions in a carrier bandwidth with respect to a reference RB to indicate a reference or virtual BWP. For example, a frequency-domain limit value may determine a start RB, or a first or a lowest RB corresponding to a reduced bandwidth transmission or reception in a carrier bandwidth. For example, a frequency-domain limit value may determine an end RB, or a last or a highest RB corresponding to a reduced bandwidth transmission or reception in a carrier bandwidth. A frequency-domain limit value may be provided to a UE, i.e., configured or indicated or assigned by the BS, or tabulated by system operating specifications for the UE. A frequency-domain limit value may be determined by the UE based on another parameter such as a frequency-domain occupancy of a BWP or a subband. For example, a CRB grid may be selected for the reference RB numbering.

In one example, a UE such as an RC UE is provided with a BWP or a subband configuration corresponding to a reduced bandwidth transmission or reception in a carrier bandwidth. The BWP or a subband configuration may be comprised of a set of BWPs or of subbands. For example, the UE determines a DL carrier BW. For example, the DL carrier BW may correspond to a transmission bandwidth configuration N_{RB}=273 PRBs, or 100 MHz, such as indicated by a SIB1, for SCS=30 kHz, and RBs numbered from 0 to 272 with respect to a common or a reference resource grid such as a CRB reference grid. The UE is provided by the BS with a set of DL BWPs or DL subbands corresponding to reduced bandwidth receptions in the DL carrier BW, e.g., a set of DL BWPs or DL subbands of size N_{BWP} or N_{SB}. For example, a size of N_{BWP}=4 or N_{SB}=4. For example, a BWP₁ or SB₁ is located on the RBs numbered 1 . . . 15, a BWP₂ or SB₂ is located on the RBs numbered 51 . . . 66, a BWP₃ or SB₃ is located on the RBs numbered 101 . . . 115, and a BWP₄ or SB₄ is located on the RBs numbered 151 . . . 166. In the example, the UE is provided with a frequency-domain limit value X_{LOW}=15 RBs or X_{HIGH}=135 RBs. In the example, the UE determines if a transmission or reception in a BWP or a subband in the carrier bandwidth is allowed or enabled or is dis-allowed or disabled based on the frequency-domain limit. For example, in the example of a frequency-domain limit value X_{LOW}=15 RBs or X_{HIGH}=200, the UE determines that a DL reception corresponding to reduced bandwidth receptions are not expected or not allowed in an RB<X_{LOW} and/or an RB>X_{HIGH}. Accordingly, the UE determines that DL reception corresponding to reduced bandwidth reception in the carrier bandwidth is not supported for BWP₁ or SB₁, not supported for BWP₄ or SB₄, but is supported for BWP₂ or SB₂ and BWP₃ or SB₃. A suitable rule may be selected for a case when a frequency-domain limit value and a BWP or subband overlap. For example, the BWP or subband may then not be selected by the UE or may be selected by the UE.

Similar implementations can be applied to UL transmissions from the UE, e.g., by replacing the terms or indexations “DL” with “UL”, or “reception” with “transmission.”

This disclosure provides a reduced complexity of the signaling indication to support an indication of frequency-hopping across BWPs or subbands by RC UEs. For example, based on the provided virtual or reference BWP in the carrier bandwidth and when the size of the frequency-domain allocation (FRDA) field is determined by the size of the virtual or reference BWP, the RC UE can then determine the field size of the FDRA field in a DL assignment or an UL grant DCI similar to the Rel-15 NR signaling fields.

In one embodiment of the present disclosure, based on the indicated BWPs or subbands in the 6G carrier BW in which the 6G RC UE may receive or transmit, or based on the virtual or reference BWP in the carrier BW, a non-RC or a RC UE can determine a corresponding frequency domain resource allocation of a DL or UL signal or channel such as the FDRA field size in the DL grant DCI, or the subband size of a CSI report.

In one embodiment, a UE further determines a field size of a DCI format, or an RBG size or an RBG set size, or a PRG bundling size or granularity, a VRB-to-PRB mapping, or a subband size for CSI-RS reception or for CSI reporting based on the indication whether a transmission or a reception in a BWP or subband in a carrier bandwidth is allowed or dis-allowed, or enabled or disabled for a frequency-domain occupancy corresponding to a reduced bandwidth transmission or reception.

For example, a UE is provided with a BWP or a subband configuration corresponding to a reduced bandwidth reception in a DL carrier bandwidth. The UE determines the DL carrier BW. For example, the DL carrier BW may correspond to a transmission bandwidth configuration N_{RB}=273 PRBs, or 100 MHz, such as indicated by a SIB1, for SCS=30 kHz, and RBs numbered from 0 to 272 with respect to a common or a reference or a virtual resource grid such as a CRB reference grid. The UE is provided by the BS with a set of DL BWPs or DL subbands corresponding to reduced bandwidth receptions in the DL carrier BW, e.g., a set of DL BWPs or DL subbands of size N_{BWP} or N_{SB}. For example, a size of N_{BWP}=4 or N_{SB}=4. For example, a BWP₁ or SB₁ is located on the RBs numbered 1 . . . 15, a BWP₂ or SB₂ is located on the RBs numbered 51 . . . 66, a BWP₃ or SB₃ is located on the RBs numbered 101 . . . 115, and a BWP₄ or SB₄ is located on the RBs numbered 151 . . . 166. In the example, no BWP or subband is of flexible type.

In one example, a UE may further determine a field size of a frequency domain resource assignment (FDRA) field in a DL assignment or an UL grant DCI format as

$$⌈ {log}_{2} ( {N}_{RB}^{usable} ( {N}_{RB}^{usable} + 1 ) / 2 ) ⌉$$

wherein the UE determines N_{RB}^{usable} based on the BWP or subband configuration corresponding to a reduced bandwidth reception in a carrier bandwidth.

For example, a UE such as a reduced complexity (or reduced capability) UE determines N_{RB}^{usable} as the sets of RBs {1-15}, {51-66}, {101-115}, and {151-166} according to the example. An FDRA field size is then determined by the UE according to a reception bandwidth across or joint for the indicated BWPs or subbands. The reception bandwidth may be non-contiguous and a number of allocated VRBs indicated by the FDRA field may be mapped by the UE to PRBs according to the BWP or subband configuration corresponding to reduced bandwidth receptions. This disclosure provides a reduced DCI size. It can be expected that the BWPs of subbands of the reduced complexity UE may be spread across the DL carrier BW. FDRA defined across or jointly then can avoid a need for two separate fields such as a BWP indicator field and an FDRA field in a DCI.

In one example, a UE such as a non-reduced complexity (or non-reduced capability) UE provided with an active/configured DL BWP on RBs 100-201 of size N_{RB}^{BWP}=101 RBs and may determine N_{RB}^{usable} as the sets of RBs {100}, {116-150}, and {167-200} according to the example. The UE may then be provided with an FDRA field of a size N_{RB}^{usable}=N_{RB}^{BWP} according to existing state-of-the-art procedure using Rel-15 NR, but may determine a VRB-to-PRB (de-)mapping based on N_{RB}^{usable} This disclosure provides increased scheduling efficiency to improve a DL throughput. It can be expected that the BWPs of subbands of the reduced complexity UE may be unevenly distributed or in the DL carrier BW. A VRB-to-PRB (de-)mapping across or jointly then can avoid a need to not assign certain resulting RBs or RBGs in partial overlap with the BWPs or subbands corresponding to reduced bandwidth reception during UE scheduling.

Similar implementations can be applied to UL transmissions from the UE, e.g., by replacing the terms or indexations “DL” with “UL”, or “reception” with “transmission.”

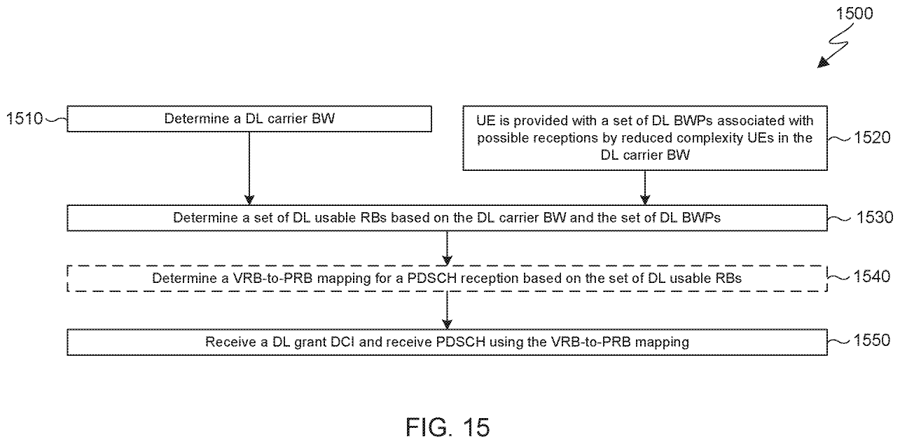

FIG. 15 illustrates an example method for determination of a virtual resource block to physical resource block (VRB-to-PRB) mapping based on DL usable RBs according to embodiments of the present disclosure. The method 1500 of FIG. 15 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1500 is for illustration only and other embodiments can be used without departing from the scope of the present disclosure.

The method 1500 begins with the UE determining a DL carrier BW (1510). Further, the UE is provided with a set of DL BWPs associated with possible receptions by reduced complexity UEs in the DL carrier BW (1520). The UE then determines a set of DL usable RBs based on the DL carrier BW and the set of DL BWPs (1530). Then, optionally, the UE determines a VRB-to-PRB mapping for a PDSCH reception based on the set of DL usable RBs (1540). The UE then receives a DL grant DCI and receives PDSCH using the VRB-to-PRB mapping (1550).

Although FIG. 15 illustrates one example method 1500 of the actions taken by the UE, various changes may be made to FIG. 15. For example, while shown as a series of steps, various steps in FIG. 15 could overlap, occur in parallel, occur in a different order, or occur any number of times.

In one embodiment, the UE is provided with by the BS, or the UE further determines a first and a second transmission or reception parameter associated with a first and a second BWP or subband, respectively, in a set of BWPs or subbands corresponding to reduced bandwidth transmission or receptions in a carrier bandwidth.

For example, a first and a second reception parameter associated with a first and a second DL BWP or DL subband corresponding to a reduced bandwidth reception in a DL carrier bandwidth, respectively, may correspond to a DL Rx EPRE value or an EPRE offset value. This disclosure provides for support for different DL MIMO capabilities when multiplexing RC and non-RC UEs in the DL carrier bandwidth. For example, a first and a second transmission parameter associated with a first and a second UL BWP or UL subband corresponding to a reduced bandwidth transmission in an UL carrier bandwidth, respectively, may correspond to a TAG or an UL timing reference. This disclosure provides for support for transmission and receptions of RC UEs in mTRP deployments.

For example, a transmission or reception parameter may correspond to one or a combination of the following:
an UL transmit power, or an UL transmit power offset, or
a DL timing reference signal, or a timing advance group
an Rx EPRE value or EPRE offset value, or a reference signal power value, or
a QCL assumption, or a value or a set of TCI states, or
a value for a bundling size such as an RBG size, a PRG bundling size, or
a CSI (sub-) reporting subband size, or
a TRP or TRPs, e.g., TRP A and/or TRP B, or a CORESETPoolIndex associated with CORESETs for PDCCH receptions, or a TRP identified by one or more SS/PBCH blocks (SSBs).
an on-demand (OD) signal for synchronization, e.g., OD-SS/PBCH Block (OD-SSB), or OD-SS, wherein OD-SS includes PSS and/or SSS or OD-low-power (LP)-SS. The OD signal for synchronization can be transmitted one or more times, or activated by a first signal/channel and transmitted periodically until it is deactivated by a second signal/channel, subject to processing latency.
an always-on (AO) signal for synchronization, e.g., AO-SS/PBCH Block (AO-SSB), or AO-SS, wherein AO-SS includes PSS and/or SSS or AO-LP-SS. The AO signal for synchronization can be configured by higher layer to be a periodic signal or a periodic burst of signals.

In one example, a UE such as a RC UE is provided with a BWP or a subband configuration corresponding to a reduced bandwidth transmission or reception in a carrier bandwidth. For example, an UL transmission by the UE may be limited or restricted to an UL BWP or UL subband corresponding to reduced bandwidth transmission. The UE is provided with a first and a second timing advance value N_{TA1} and N_{TA2} corresponding to an UL transmit timing in a first UL BWP or subband and a second UL BWP or subband, respectively. The first value N_{TA1} may be used by the UE to determine an UL transmit timing for an UL signal or channel transmitted in the UL BWP₁ or UL SB₁. The second value N_{TA2} may be used by the UE to determine an UL transmit timing for an UL signal or channel transmitted in the UL BWP₂ or UL SB₂.

In one embodiment of the present disclosure, the BS indicates to a UE or the UE determines a first set of BWPs or subbands on a first symbol/slot type such as DL symbols/slots and a second symbol/slot type such as F symbols/slots for the BWPs or subbands corresponding to transmissions or receptions by RC UEs in the carrier BW. A slot/symbol type specific parameterization of the frequency hopping parameters of behavior when 6G UEs are co-deployed on an NR TDD, e.g., set 1 and set 2, may also be used as time-domain restriction for the frequency-hopping patter or behavior of the RC UE. For example, transmission or receptions by RC UEs in the carrier BW may be enabled or disabled in certain slots/symbols.

In one embodiment of the present disclosure, the BS indicates to a UE or the UE determines a first set of BWPs or subbands associated with pattern p1 of a TDD UL-DL frame configuration and a second set of BPWs or subbands associated with pattern p2 of a TDD UL-DL frame configuration for the BWPs or subbands corresponding to transmissions or receptions by RC UEs in the carrier BW.

This disclosure provides for support of separate frequency-hopping patterns or separate frequency-hopping behaviors for D slots/symbols and F slots/symbols, respectively, in NR TDD, or for SBFD and non-SBFD slots, respectively, when an RC UE operates on a 6G carrier with NR TDD coexistence. For example, receptions by or transmissions from the 6G RC UEs can then be restricted on certain time-domain resources which can increase the spectral efficiency or cell aggregate throughput in the remaining time-domain resources. For example, frequency-hopping on the different slot/symbol types can then use different hopping bandwidths or a different number of hops in the carrier BW on the different slot/symbol types according to the needs of the NR TDD carrier (with or without SBFD). For example, a smaller number of hopping BWPs or subbands may be configured in the TDD flexible symbols than in the TDD DL symbols, or in the SBFD symbols on DL or F symbols than in UL symbols on the carrier where a smaller UL transmission bandwidth may be available for RC UEs when operating in coexistence with an NR TDD carrier. This disclosure provides for slot specific parameterization of the frequency-hopping behavior of RC UEs when co-deployed with NR UEs is FDD operation such as in FR1 bands below 1 GHz. For example, set 1 may be provided to enable a large hopping bandwidth for RC UEs in the carrier BW to improve UL performance of RC UEs at expense of fracturing the contiguous UL scheduling BW for NR FDD UEs, and set 2 may be provided to enable a smaller hopping bandwidth in certain slots to protect UL SRS transmissions from non-RC UEs.

In one embodiment, the UE determines a first and a second number of BWPs or subbands for frequency-hopping in a carrier bandwidth for transmission or reception by a reduced complexity UE based on a slot/symbol type or based on a pattern such as p1 or p2 provided by a TDD UL-DL frame configuration.

In a variation, the UE determines a first and a second location in frequency-domain of a BWP or a subband in a carrier bandwidth for transmission or reception by a reduced complexity UE based on slot/symbol type. In a variation, the UE determines if transmission or reception by a reduced complexity UE in a BWP or subband is allowed/dis-allowed or enabled/disabled based on a first or a second slot/symbol type. In a variation, the UE determines a first and a second set of slots/symbols in a duration for transmission or reception by a reduced complexity UE wherein the first and the second set of slots/symbols are associated with a different slot/symbol type.

In one example, the information provided to the UE whether a transmission or reception in a BWP or a subband in the carrier bandwidth is allowed or enabled, or dis-allowed or disabled, may correspond to an indicated slot or symbol type, or a set of slots/symbols, or a valid or invalid type of slot or symbol, or an NR TDD UL-DL frame configuration, or a signal or channel type, or a transmission or reception format, or a priority level. When a set of BWPs or of subbands corresponding to a reduced bandwidth transmission or reception is provided to the UE, the UE determines if a transmission or reception is allowed or enabled, or dis-allowed or enabled for an indicated BWP or subband based on the slot or symbol type. For example, the UE is provided by the BS with an indicated type of slot/symbol or a set of slots/symbols or a valid or invalid type of slot or symbol associated with a BWP or a subband corresponding to a reduced bandwidth transmission or reception.

For example, a slot or symbol type may correspond to one of or a combination of:
a symbol or slot type such as corresponding to a transmission direction, e.g., ‘D’ or ‘F’ or ‘U’, or
a symbol or slot type such as corresponding to a transmission direction, e.g., ‘simultaneous Tx-Rx’ or ‘no simultaneous Tx-Rx’ or ‘SBFD’ or ‘non-SBFD’, or
a symbol or slot type associated with a network energy saving state, e.g., ‘DTX’ or ‘non-DTX’ or ‘DRX’ or ‘non-DRX’, or
a type of symbol or slot such as ‘valid’ or ‘invalid’ or ‘enabled’ or ‘disabled’.

For example, a set of slots or symbols may be provided to the UE by a bitmap, or a list of symbol or slot indices, or as a resource indicator value such as SLIV with a starting slot or symbol value and a run length value.

For example, an NR TDD UL-DL frame configuration to determine a pattern p1 or p2 may be provided to the UE based on parameter tdd-UL-DL-ConfigurationCommon and/or tdd-UL-DL-ConfigurationDedicated using higher layer signaling. For example, the UE may determine a TDD UL-DL frame configuration of a serving cell by receiving a SIB such as a SIB1 when accessing the cell from RRC_IDLE, or by higher layer signaling when the UE is configured with an SCell or additional SCGs by an IE ServingCellConfigCommon in RRC_CONNECTED.

For example, a signal or channel type, or a transmission or reception format may correspond to one of or a combination of:
a cell-defining, or non-defining, or on-demand SSB, or a long or a short SSB format
a PDCCH, or a PDSCH, or CSI-RS, or PTRS
a PUCCH, or a PUSCH, or a PRACH, or an SRS

In one example, the UE is indicated by the BS with a slot/symbol type in a carrier or in a band of a band combination on which a reduced bandwidth transmission or reception based on a set of BWPs or subbands may be applied or may not applied. For example, the UE may be indicated by the BS that DL receptions in the set of DL BWPs or DL subbands corresponding to reduced bandwidth receptions are possible or allowed in a slot/symbol type ‘D’ but are not possible or not allowed in a slot/symbol type ‘F’. For example, the UE may be indicated by the BS that UL transmissions in the set of UL BWPs or UL subbands corresponding to reduced bandwidth transmissions are possible or allowed in a slot/symbol type ‘U’, but are not possible or not allowed in a slot/symbol type ‘F’. The UE then applies the provided configuration with the set of DL BWPs or DL subbands in slots or symbols of type ‘D’ but does not receive in the slots or symbols of type ‘F’. For example, the UE may apply the frequency hopping configuration for DL receptions in the set of DL slots in the set of DL BWPs or DL subbands corresponding to reduced bandwidth receptions but does not receive in the flexible slots. The UE applies the provided configuration with the set of UL BWPs or UL subbands in slots or symbols of type ‘U’ but does not receive in the slots or symbols of type ‘F’. For example, the UE may apply the frequency hopping configuration for UL transmissions in the set of UL slots in the set of UL BWPs or UL subbands corresponding to reduced bandwidth transmissions but does not transmit in the flexible slots.

In one example, the UE is indicated by the BS, or the UE determines an NR TDD UL-DL frame configuration such as parameter tdd-UL-DL-ConfigurationCommon for a carrier in a band in which a reduced bandwidth transmission or reception based on a set of BWPs or subbands may be applied or may not applied. For example, tdd-UL-DL-ConfigurationCommon may indicate one pattern p1 or two patterns p1 and p2. For example, the UE may be indicated by the BS that DL receptions in DL slots/symbols corresponding to pattern p1 for the set of DL BWPs or DL subbands corresponding to reduced bandwidth receptions are possible or allowed, but are not possible or not allowed in DL slots/symbols corresponding to pattern p2. For example, the UE may be indicated by the BS that UL transmissions in the set of UL BWPs or UL subbands corresponding to reduced bandwidth transmissions are possible or allowed in a slot/symbol type ‘U’ of both patterns p1/p2. The UE then applies the provided configuration with the set of DL BWPs or DL subbands in slots or symbols of type ‘D’ of pattern p1 but does not receive in the slots or symbols of type ‘D’ of pattern p2. For example, the UE may apply the frequency hopping configuration for DL receptions in the set of DL slots in the set of DL BWPs or DL subbands corresponding to reduced bandwidth receptions in the slots or symbols of type ‘D’ of pattern p1. The UE applies the provided configuration with the set of UL BWPs or UL subbands in slots or symbols of type ‘U’ corresponding to patterns p1 and p2. For example, the UE may apply the frequency hopping configuration for UL transmissions in the set of UL slots of patterns p1 and p2 in the set of UL BWPs or UL subbands corresponding to reduced bandwidth transmissions.

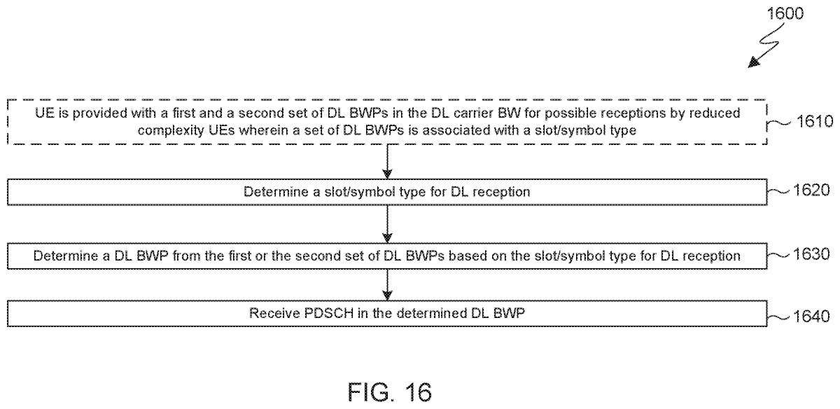

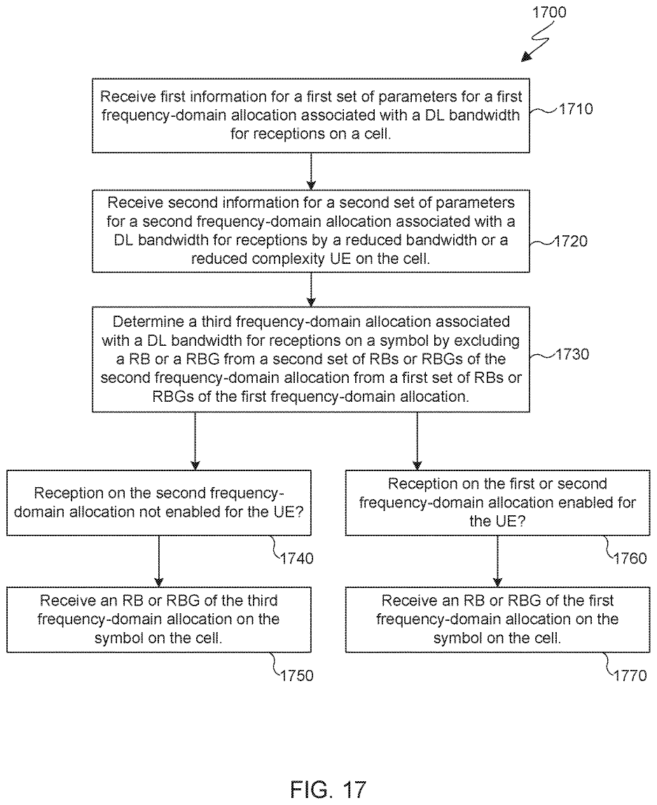

FIG. 16 illustrates an example method 1600 for determination of a frequency hopping pattern based on a symbol or slot type according to embodiments of the present disclosure. The method 1600 of FIG. 16 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 1600 is for illustration only and other embodiments can be used without departing from the scope of the present disclosure.

The method 1600 begins, optionally, with the UE being provided with a first and a second set of DL BWPs in the DL carrier BW for possible receptions by reduced complexity UEs wherein a set of DL BWPs is associated with a slot/symbol type (1610). The UE then determines a slot/symbol type for DL reception (1620). The UE then determines a DL BWP from the first or the second set of DL BWPs based on the slot/symbol type for DL reception (1630). The UE then receives PDSCH in the determined DL BWP (1640).

Although FIG. 16 illustrates one example method 1600 of the actions taken by the UE, various changes may be made to FIG. 16. For example, while shown as a series of steps, various steps in FIG. 16 could overlap, occur in parallel, occur in a different order, or occur any number of times.

FIG. 17 illustrates an example method 1700 performed by a UE according to embodiments of the present disclosure. The method 1700 of FIG. 17 can be performed by any of the UEs 111-117 of FIG. 1, such as the UE 117 of FIG. 3, and a corresponding method can be performed by any of the BSs 101-103 of FIG. 1, such as BS 102 of FIG. 2. The method 1700 is for illustration only and other embodiments can be used without departing from the scope of the present disclosure.

The method 1700 begins with the UE receiving first information for a first set of parameters for a first frequency-domain allocation associated with a DL bandwidth for receptions on a cell (1710). The UE then receives second information for a second set of parameters for a second frequency-domain allocation associated with a DL bandwidth for receptions by a reduced bandwidth or a reduced complexity UE on the cell (1720).

The UE then determines a third frequency-domain allocation associated with a DL bandwidth for receptions on a symbol by excluding a RB or a RBG from a second set of RBs or RBGs of the second frequency-domain allocation from a first set of RBs or RBGs of the first frequency-domain allocation. For example, in 1730, the first set of RBs of RBGs of the first frequency-domain allocation corresponds to a set of RBs or RBGs based on one of a carrier bandwidth, a BWP, or a frequency-domain allocation with upper and lower limits. The second set of RBs or RBGs of the second frequency-domain allocation corresponds to a subset of the first RBs or RBGs of the first frequency-domain allocation.

When reception on the second frequency-domain allocation is not enabled for the UE (1740), the UE receives an RB or RBG of the third frequency-domain allocation on the symbol on the cell (1750). When reception on the first or second frequency-domain allocation is enabled for the UE (1760), the UE receives an RB or RBG of the first frequency-domain allocation on the symbol on the cell (1770).

In various embodiments, the UE determines first and second parameters associated with receptions in an RB or RBG of the first and second frequency-domain allocations, respectively. The first or second parameters corresponds to one of an EPRE value, a TCI value, a CSI resource, a CSI reporting subband size, an RBG size, or a PRG size. The UE one of receives the RB or RBG of the first frequency-domain allocation based on the first parameter or receives the RB or RBG of the second frequency-domain allocation based on the second parameter.

In various embodiments, the UE determines an RB or RBG of the second frequency-domain allocation on the symbol based on a slot or symbol number and a frequency-hopping offset value.

In various embodiments, the UE determines a maximum number of RBs or RBGs of the second frequency-domain allocation for reception on the symbol. For example, the maximum number of RBs or RBGs is smaller than a number of RBs of RBGs in the second set of RBs or RBGs of the second frequency-domain allocation. The UE receives an RB or RBG of the second frequency-domain allocation according to the maximum number.

In various embodiments, second information indicates a first set of symbols or slots indicated for reception or a second set of symbols or slots not indicated for reception by a reduced bandwidth or a reduced complexity UE on the cell. The UE determines an RB or RBG of the second frequency-domain allocation on the symbol based on the first or the second set of symbol or slots.

In various embodiments, the first set of RBs or RBGs of the first frequency-domain allocation on a symbol corresponds to a non-contiguous set of physical RBs or RBG for a virtual set of RBs or RBG in a contiguous or a non-contiguous reception bandwidth.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

1. A method of operating a user equipment (UE), the method comprising:
receiving first information for a first set of parameters for a first frequency-domain allocation associated with a downlink (DL) bandwidth for receptions on a cell;
receiving second information for a second set of parameters for a second frequency-domain allocation associated with a DL bandwidth for receptions by a reduced bandwidth or a reduced complexity UE on the cell;
determining a third frequency-domain allocation associated with a DL bandwidth for receptions on a symbol by excluding a resource block (RB) or a resource block group (RBG) from a second set of RBs or RBGs of the second frequency-domain allocation from a first set of RBs or RBGs of the first frequency-domain allocation, wherein:
the first set of RBs of RBGs of the first frequency-domain allocation corresponds to a set of RBs or RBGs based on one of a carrier bandwidth, a bandwidth part (BWP), or a frequency-domain allocation with upper and lower limits, and
the second set of RBs or RBGs of the second frequency-domain allocation corresponds to a subset of the first RBs or RBGs of the first frequency-domain allocation; and
one of:
receiving an RB or RBG of the third frequency-domain allocation on the symbol on the cell when reception on the second frequency-domain allocation is not enabled for the UE; or
receiving an RB or RBG of the first frequency-domain allocation on the symbol on the cell when reception on the first or second frequency-domain allocation is enabled for the UE.

2. The method of claim 1, further comprising:
determining first and second parameters associated with receptions in an RB or RBG of the first and second frequency-domain allocations, respectively, wherein the first or second parameters corresponds to one of an energy-per-resource-element (EPRE) value, a transmission configuration indicator (TCI) value, a channel state information (CSI) resource, a CSI reporting subband size, an RBG size, or a precoding resource group (PRG) size; and
one of:
receiving the RB or RBG of the first frequency-domain allocation based on the first parameter; or
receiving the RB or RBG of the second frequency-domain allocation based on the second parameter.

3. The method of claim 1, further comprising determining an RB or RBG of the second frequency-domain allocation on the symbol based on (i) a slot or symbol number and (ii) a frequency-hopping offset value.

4. The method of claim 1, further comprising:
determining a maximum number of RBs or RBGs of the second frequency-domain allocation for reception on the symbol, wherein the maximum number of RBs or RBGs is smaller than a number of RBs of RBGs in the second set of RBs or RBGs of the second frequency-domain allocation; and
receiving an RB or RBG of the second frequency-domain allocation according to the maximum number.

5. The method of claim 1, wherein:
the second information indicates (i) a first set of symbols or slots indicated for reception or (ii) a second set of symbols or slots not indicated for reception by a reduced bandwidth or a reduced complexity UE on the cell, and
the method further comprises determining an RB or RBG of the second frequency-domain allocation on the symbol based on the first or the second set of symbol or slots.

6. The method of claim 1, wherein the first set of RBs or RBGs of the first frequency-domain allocation on a symbol corresponds to a non-contiguous set of physical RBs or RBG for a virtual set of RBs or RBG in a contiguous or a non-contiguous reception bandwidth.

7. A user equipment (UE), comprising:
a transceiver configured to:
receive first information for a first set of parameters for a first frequency-domain allocation associated with a downlink (DL) bandwidth for receptions on a cell, and
receive second information for a second set of parameters for a second frequency-domain allocation associated with a DL bandwidth for receptions by a reduced bandwidth or a reduced complexity UE on the cell; and
a processor operably coupled to the transceiver, the processor configured to determine a third frequency-domain allocation associated with a DL bandwidth for receptions on a symbol by excluding a resource block (RB) or a resource block group (RBG) from a second set of RBs or RBGs of the second frequency-domain allocation from a first set of RBs or RBGs of the first frequency-domain allocation,
wherein the first set of RBs of RBGs of the first frequency-domain allocation corresponds to a set of RBs or RBGs based on one of a carrier bandwidth, a bandwidth part (BWP), or a frequency-domain allocation with upper and lower limits,
wherein the second set of RBs or RBGs of the second frequency-domain allocation corresponds to a subset of the first RBs or RBGs of the first frequency-domain allocation, and
wherein the transceiver is further configured to one of:
receive an RB or RBG of the third frequency-domain allocation on the symbol on the cell when reception on the second frequency-domain allocation is not enabled for the UE; or
receive an RB or RBG of the first frequency-domain allocation on the symbol on the cell when reception on the first or second frequency-domain allocation is enabled for the UE.

8. The UE of claim 7, wherein:
the processor is further configured to determine first and second parameters associated with receptions in an RB or RBG of the first and second frequency-domain allocations, respectively,
the first or second parameters corresponds to one of an energy-per-resource-element (EPRE) value, a transmission configuration indicator (TCI) value, a channel state information (CSI) resource, a CSI reporting subband size, an RBG size, or a precoding resource group (PRG) size, and
the transceiver is further configured to one of:
receive the RB or RBG of the first frequency-domain allocation based on the first parameter; or
receive the RB or RBG of the second frequency-domain allocation based on the second parameter.

9. The UE of claim 7, wherein the processor is further configured to determine an RB or RBG of the second frequency-domain allocation on the symbol based on (i) a slot or symbol number and (ii) a frequency-hopping offset value.

10. The UE of claim 7, wherein:
the processor is further configured to determine a maximum number of RBs or RBGs of the second frequency-domain allocation for reception on the symbol, wherein the maximum number of RBs or RBGs is smaller than a number of RBs of RBGs in the second set of RBs or RBGs of the second frequency-domain allocation; and
the transceiver is further configured to receive an RB or RBG of the second frequency-domain allocation according to the maximum number.

11. The UE of claim 7, wherein:
the second information indicates (i) a first set of symbols or slots indicated for reception or (ii) a second set of symbols or slots not indicated for reception by a reduced bandwidth or a reduced complexity UE on the cell, and
the processor is further configured to determine an RB or RBG of the second frequency-domain allocation on the symbol based on the first or the second set of symbol or slots.

12. The UE of claim 7, wherein the first set of RBs or RBGs of the first frequency-domain allocation on a symbol corresponds to a non-contiguous set of physical RBs or RBG for a virtual set of RBs or RBG in a contiguous or a non-contiguous reception bandwidth.

13. A base station, comprising:
a processor; and
a transceiver operably coupled to the processor, the transceiver configured to:
transmit first information for a first set of parameters for a first frequency-domain allocation associated with a downlink (DL) bandwidth for transmissions on a cell; and
transmit second information for a second set of parameters for a second frequency-domain allocation associated with a DL bandwidth for transmissions to a reduced bandwidth or a reduced complexity UE on the cell,
wherein a third frequency-domain allocation associated with a DL bandwidth for transmissions on a symbol is based on excluding a resource block (RB) or a resource block group (RBG) from a second set of RBs or RBGs of the second frequency-domain allocation from a first set of RBs or RBGs of the first frequency-domain allocation,
wherein the first set of RBs of RBGs of the first frequency-domain allocation corresponds to a set of RBs or RBGs based on one of a carrier bandwidth, a bandwidth part (BWP), or a frequency-domain allocation with upper and lower limits,
wherein the second set of RBs or RBGs of the second frequency-domain allocation corresponds to a subset of the first RBs or RBGs of the first frequency-domain allocation, and
wherein the transceiver is further configured to one of:
transmit an RB or RBG of the third frequency-domain allocation on the symbol on the cell when transmission on the second frequency-domain allocation is not enabled for the UE, or
transmit an RB or RBG of the first frequency-domain allocation on the symbol on the cell when transmission on the first or second frequency-domain allocation is enabled for the UE.

14. The base station of claim 13, wherein:
the processor is configured to determine first and second parameters associated with transmissions in an RB or RBG of the first and second frequency-domain allocations, respectively,
the first or second parameters corresponds to one of an energy-per-resource-element (EPRE) value, a transmission configuration indicator (TCI) value, a channel state information (CSI) resource, a CSI reporting subband size, an RBG size, or a precoding resource group (PRG) size; and
the transceiver is further configured to one of:
transmit the RB or RBG of the first frequency-domain allocation based on the first parameter; or
transmit the RB or RBG of the second frequency-domain allocation based on the second parameter.

15. The base station of claim 13, wherein an RB or RBG of the second frequency-domain allocation on the symbol is based on (i) a slot or symbol number and (ii) a frequency-hopping offset value.

16. The base station of claim 13, wherein:
a maximum number of RBs or RBGs, of the second frequency-domain allocation for transmission on the symbol, is smaller than a number of RBs of RBGs in the second set of RBs or RBGs of the second frequency-domain allocation, and
the transceiver is further configured to transmit an RB or RBG of the second frequency-domain allocation according to the maximum number.

17. The base station of claim 13, wherein:
the second information indicates (i) a first set of symbols or slots indicated for transmission or (ii) a second set of symbols or slots not indicated for transmission by a reduced bandwidth or a reduced complexity UE on the cell, and
an RB or RBG of the second frequency-domain allocation on the symbol is based on the first or the second set of symbol or slots.

18. The base station of claim 13, wherein the first set of RBs or RBGs of the first frequency-domain allocation on a symbol corresponds to a non-contiguous set of physical RBs or RBG for a virtual set of RBs or RBG in a contiguous or a non-contiguous transmission bandwidth.
